(19) United States
(12) Patent Application Publication
(10) Pub. No.: US 2014/0186815 A1
(43) Pub. Date: Jul. 3, 2014

(54) System and Method for What-If Analysis of a University Based On University Model Graph

(71) Applicant: SRM Institute of Science and Technology, Chennai (IN)

(72) Inventors: Sindhar Varadarajan, Bangalore (IN); Srividya Gopalan, Bangalore (IN); Preethy Iyer, Bangalore (IN); Amit Thawani, Bangalore (IN)

(73) Assignee: SRM Institute of Science and Technology, Chennai (IN)

(21) Appl. No.: 14/090,658

(22) Filed: Nov. 26, 2013

Related U.S. Application Data
(63) Continuation-in-part of application No. 13/025,325, filed on Feb. 11, 2011, now abandoned.

(30) Foreign Application Priority Data
Oct. 28, 2010 (IN) 3203/CHE/2010

(51) Int. Cl. G09B 7/00

(52) U.S. Cl. CPC G09B 7/00
USPC 434/350

(57) ABSTRACT

An educational institution (also referred as a university) is structurally modeled using a university model graph. A key benefit of modeling of the educational institution is to help in an introspective analysis by the educational institute. Specifically, the model is quite beneficial for undertaking the analysis of the various issues faced by the educational institute. A what-if scenario requires the model to be suitably changed to address the issue under consideration and the changed model needs to be analyzed to determine how the issue could be handled. A system and method for what-if scenario analysis based on the university model graph is discussed.

### CROSS REFERENCE TO RELATED APPLICATION

This is a Continuation of application of the USPTO patent application Ser. No. 13/025,325, filed on Nov. 2, 2011 which is hereby incorporated in its entirety by reference.

The disclosure of a prior application that is a continuation of the USPTO application Ser. No. 12/909,988 filed on Oct. 22, 2010 is hereby incorporated in its entirety by reference.

1. A reference is made to the applicants' earlier Indian patent application titled “System and Method for an Influence based Structural Analysis of a University” with the application number 1269/CHE2010 filed on 6 May 2010.

2. A reference is made to another of the applicants' earlier Indian patent application titled “System and Method for Constructing a University Model Graph” with an application number 1809/CHE/2010 and filing date of 28 Jun. 2010.

3. A reference is made to yet another of the applicants' earlier Indian patent application titled

“System and Method for University Model Graph based Visualization” with the application number 1848/CHE/2010 dated 30 Jun. 2010.

### FIELD OF THE INVENTION

The present invention relates to the analysis of the information about a university in general, and more particularly, the analysis of the university based on the structural representations. Still more particularly, the present invention relates to a system and method for what-if analysis based on a model graph associated with the university.

### BACKGROUND OF THE INVENTION

A what-if analysis is typically a hypothetical analysis in which the parameters of a system being analyzed are hypothetically changed so as to determine the new system behavior. Such an analysis helps in determining what happens if the system parameters change in a particular manner. Again, typically, this is done in a simulated environment that uses a model of the system being what-if analyzed. What-if analysis is common and has been used to obtain practical insights in many domains: financial, industrial, process, and business domains to name just a few.

An Educational Institution (EI) (also referred as University) comprises of a variety of entities: students, faculty members, departments, divisions, labs, libraries, special interest groups, etc.

University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (l) News and Events; (m) Alumni; and (n) Information Resources. The educational institutions are positioned in a very competitive environment and it is a constant endeavor of the management of the educational institution to ensure to be ahead of the competition. This calls for a critical analysis of the overall functioning of the university and help suggest improvements so as enhance the overall strength aspects and overcome the weaknesses. Consider as a typical scenario involving an allocation of funds to the various laboratories of the institution: it makes sense to allocate funds to those labs that provide opportunities for more faculty members to undertake their research work; this in turn would involve more students as research assistants; this double headed improvement leads to the overall enhanced assessment of the institution. Similarly, consider a scenario of enhancing the overall assessment of a faculty member: in this case, encouraging the faculty member to attend a technical conference and present their work would help enhance the influencing factors with respect to both peer faculty members and students. These illustrative scenarios call for what-if analysis based on a model of the institution to obtain better and practical insights into the institution.

### DESCRIPTION OF RELATED ART

U.S. Pat. No. 7,606,165 to Qiu; Lili (Bellevue, Wash.), Bahl; Paramvir (Sammamish, Wash.), Zhou; Lidong (Sunnyvale, Calif.), Rao; Ananth Rajagopala (El Cerrito, Calif.) for “What-if analysis for network diagnostics” (issued on Oct. 20, 2009 and assigned to Microsoft Corporation (Redmond, Wash.)) describes a network troubleshooting framework for performing what-if analysis of wired and wireless networks.

U.S. Patent Application 20100198958 titled “Real-Time Feedback for Policies for Computing System Management” by Cannon; David M.; (Tucson, Ariz.) ; Humphries; Marshall L.; (Tucson, Ariz.) (filed on Apr. 14, 2010 and assigned to International Business Machines Corporation, Armonk, N.Y.) describes a method for providing real-time feedback regarding the effect of applying a policy definition used for management in a computing system.

“Adding Change Impact Analysis to the Formal Verification of C Programs” by Autexier; Serge and Luth; Christoph (appeared in Dominique Mery and Stephan Merz (Eds.), Proceedings 8th International Conference on integrated Formal Methods (IFM2010), LNCS, Nancy, France, Springer, October, 2010) describes a framework based on document graph model to handle changes to programs and specifications efficiently as part of formal software verification.

“Modularity-Driven Clustering of Dynamic Graphs” by Gorke; Robert, Maillard; Pascal, Staudt; Christian, and Wagner; Dorothea (appeared in Experimental Algorithms, Lecture Notes in Computer Science, 2010, Volume 6049/2010, 436-448) describes graph analysis algorithms for efficiently maintaining a modularity based clustering of a graph that changes dynamically.

“A Graph-Theory Framework for Evaluating Landscape Connectivity and Conservation Planning” by Minor; Emily and Urban; Dean (appeared in Conservation Biology (Wiley-Blackwell), Volume 22, Issue 2, Pages 297-307, April 2008) describes a graph-theoretic approach to characterize multiple aspects of landscape connectivity in a habitat network and uses the notions of graph measures such as compartmentalization and clustering for the purposes of analysis.

The known systems do not address the issue of what-if analysis based on a comprehensive modeling of an educational institution at various levels in order to be able to provide for introspective analysis. The present invention provides for a system and method for what-if analysis based on a university model graph of the educational institution.

### SUMMARY OF THE INVENTION

The primary objective of the invention is to achieve what-if analysis based on a university model graph (UMG) associated with an educational institution to help the educational institution in an introspective analysis.

One aspect of the present invention is to analyze a what-if analysis request and to derive a revised optimized university model graph.

Another aspect of the present invention is to interpret the revised optimized university model graph and generate recommendations.

Yet another aspect of the present invention is to find an optimal sub-UMG based on the university model graph.

Another aspect of the present invention is to minimally change to tune the university model graph so as achieve the set base scores of the select nodes of the university model graph.

Yet another aspect of the present invention is to determine the best set of entities and entity-instances among a few sets based on the university model graph.

Another aspect of the present invention is to select a sub-UMG and tune the sub-UMG.

Yet another aspect of the invention is to achieve the tuning of the university model graph based on a set of influence values.

Another aspect of the present invention is to achieve combining of two or more university model graphs.

In a preferred embodiment the present invention provides a system for the what-if analysis of a plurality of what-if requests based on a university model graph (UMG) of a university to generate a plurality of recommendations based on a plurality of assessments and a plurality of influence values contained in a university model graph database to help in undertaking introspective analysis of said university, said university having a plurality of entities and a plurality of entity-instances,
wherein each of said plurality of entity-instances is an instance of an entity of said plurality of entities, and said university model graph having a plurality of models, a plurality of abstract nodes, a plurality of nodes, a plurality of abstract edges, a plurality of semi-abstract edges, and a plurality of edges,
with each abstract node of said plurality of abstract nodes corresponding to an entity of said plurality of entities,
each node of said plurality of nodes corresponding to an entity-instance of said plurality of entity-instances, and
each abstract node of said plurality of abstract nodes is associated with a model of said plurality of models, and
a node of said plurality of nodes is connected to an abstract node of said plurality of abstract nodes through an abstract edge of said plurality of abstract edges, wherein said node represents an instance of an entity associated with said abstract node and said node is associated with an instantiated model and a base score, wherein said instantiated model is based on a model associated with said abstract node, and said base score is computed based on said instantiated model and is a value between 0 and 1,
a source abstract node of said plurality of abstract nodes is connected to a destination abstract node of said plurality of abstract nodes by a directed abstract edge of said plurality of abstract edges and said directed abstract edge is associated with an entity influence value of said plurality of influence values, wherein said entity influence value is a value between −1 and +1;
a source node of said plurality of nodes is connected to a destination node of said plurality of nodes by a directed edge of said plurality of edges and said directed edge is associated with an influence value of said plurality influence values, wherein said influence value is a value between −1 and +1;
a source node of said plurality of nodes is connected to a destination abstract node of said plurality of abstract nodes by a directed semi-abstract edge of said plurality of semi-abstract edges and said directed semi-abstract edge is associated with an entity-instance-entity-influence value of said plurality influence values, wherein said entity-instance-entity-influence value is a value between -1 and +1; and
a source abstract node of said plurality of abstract nodes is connected to a destination node of said plurality of nodes by a directed semi-abstract edge of said plurality of semi-abstract edges and said directed semi-abstract edge is associated with an entity-entity-instance-influence value of said plurality influence values, wherein said entity-entity-instance-influence value is a value between −1 and +1,
said system comprising,
   means for deriving of a revised optimized university model graph based on a what-if request of said plurality of what-if requests and said UMG; and
   means for generating of a recommendation of said plurality of recommendations based on said revised optimized university model graph;
   wherein said means for deriving of said revised optimized university model graph further comprises of:
      means for generating of an optimal sub-UMG based on said UMG and assigning of said optimal sub-UMG as said revised optimized university model graph;
      means for generating of a tuned UMG based on said UMG and a plurality of select nodes, wherein each select node of said plurality of select nodes is a part of said plurality of abstract nodes or a part of said plurality of bodes, and is associated with an expected base score, and assigning of said tuned UMG as said revised optimized university model graph;
      means for selecting of a best set of a plurality of sets based on said UMG, wherein each set of said plurality of sets comprises of a plurality of selected abstract nodes of said plurality of abstract nodes and a plurality of selected nodes of said plurality of nodes, and assigning of said best set as said revised optimized university model graph;
      means for local analysis of said UMG to generate a local sub-UMG;
      means for generating of a tuned sub-UMG based on said local sub-UMG, and assigning of said tuned sub-UMG as said revised optimized university model graph;
      means for selecting of a local best set of a plurality of local sets based on said local sub-UMG, wherein each set of said plurality of local sets comprises of a plurality of selected abstract nodes of said plurality of abstract nodes and a plurality of selected nodes of said plurality of nodes, and assigning of said best set as said revised optimized university model graph;
      means for generating of an influence tuned UMG based on said UMG and a plurality of select node pairs, wherein a node pair of said plurality of node pairs comprises of a node 1 of said node pair is a part of said plurality of abstract nodes or said plurality of nodes, a node 2 of said node pair is a part of said plurality of abstract nodes or said plurality of nodes, and assigning of said influence tuned UMG as said revised optimized university model graph;
      means for generating of an influence tuned UMG 2 based on said UMG, and assigning of said influence tuned UMG 2 as said revised optimized university model graph; and
      means for combining of a plurality of additional university model graphs and said UMG to generate a combined UMG, and assigning of said combined UMG as said revised optimized university model graph.

(REFER TO FIGS. 1-3 and FIG. 5)

### BRIEF DESCRIPTION OF THE DRAWINGS

FIG. 1 provides an overview of EI Analysis System.

FIG. 1A provides an illustrative University Model Graph.

FIG. 1B provides the elements of University Model Graph.

FIG. 2 provides a Partial List of Entities of a University.

FIG. 3 provides illustrative What-If Scenarios.

FIG. 4 provides illustrative Recommendations.

FIG. 4A provides additional illustrative Recommendations.

FIG. 5 provides an overview of Generic UMG Analysis Techniques.

FIG. 6 provides an overview of Approach for Technique 1.

FIG. 6A provides an Approach for Technique 1.

FIG. 7 provides an Approach for Technique 2.

FIG. 8 provides an Approach for Technique 3.

FIG. 9 provides an Approach for Technique 4.

FIG. 10 provides an Approach for Technique 5.

FIG. 10A provides additional information on Approach for Technique 5.

FIG. 11 provides an Approach for Technique 6.

FIG. 12 provides an overview of Generating Recommendations.

FIG. 12A provides additional information related to Generating of Recommendations.

FIG. 12B provides more information related to Generating of Recommendations.

FIG. 12C provides further more information related to Generating of Recommendations.

FIG. 13 provides an illustrative UMG for Analysis.

FIG. 13A provides an illustrative Analysis Result related to Tuning of UMG.

FIG. 14 depicts an illustrative University What-IF Analysis System.

FIG. 15 depicts an approach for What-If Analysis for Leadership abilities.

FIG. 15A provides an illustrative evolution of Leadership abilities.

FIG. 15B provides an approach for the analysis for Normal to Onset transition in Leadership abilities.

FIG. 15C depicts an approach for the analysis for transition from Onset to Demonstrating of Leadership abilities.

FIG. 15D depicts an approach for the analysis for transition from Demonstrating to Maturity in Leadership abilities.

FIG. 16 provides an approach What-If analysis for Mentorship abilities.

FIG. 16A depicts an illustrative evolution of Mentorship abilities.

FIG. 16B depicts an approach for the analysis for Normal to Onset transition in Mentorship abilities.

FIG. 16C provides an approach for the analysis for transition from Onset to Maturity in Mentorship abilities.

FIG. 17 provides an approach for What-If analysis for Dependability.

FIG. 17A depicts an illustrative evolution of Dependability.

FIG. 17B provides an approach for the analysis for Normal to Maturity transition in Dependability.

FIG. 18 depicts an illustrative computation of What-If analysis of Leadership abilities.

FIG. 18A depicts an illustrative computation of What-If analysis of Mentorship abilities.

FIG. 18B provides an illustrative computation of What-If analysis of Dependability.

FIG. 18C provides additional information related to the illustrative computation of What-If analysis of Dependability.

### DETAILED DESCRIPTION OF THE PREFERRED EMBODIMENTS

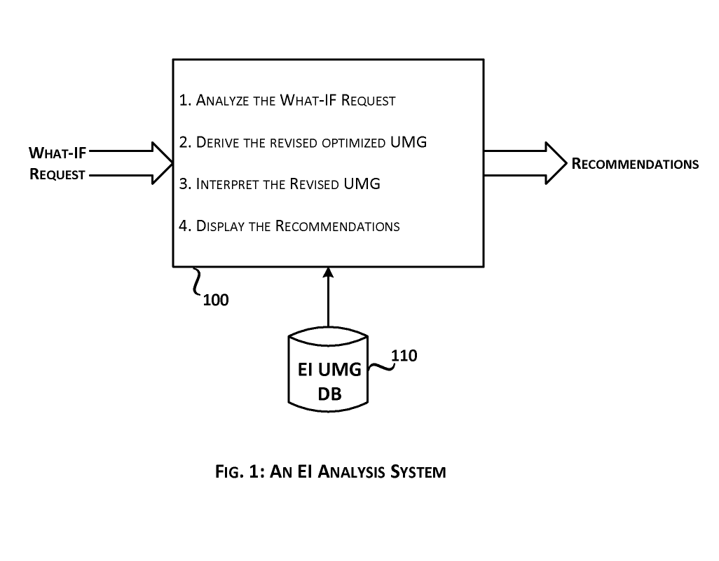

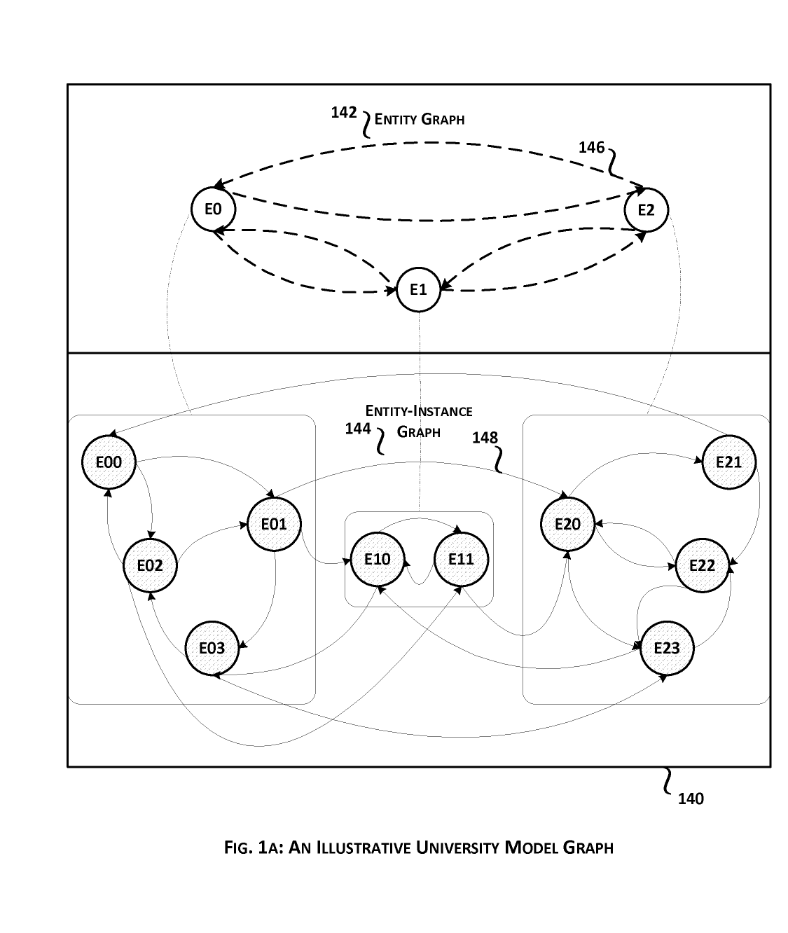

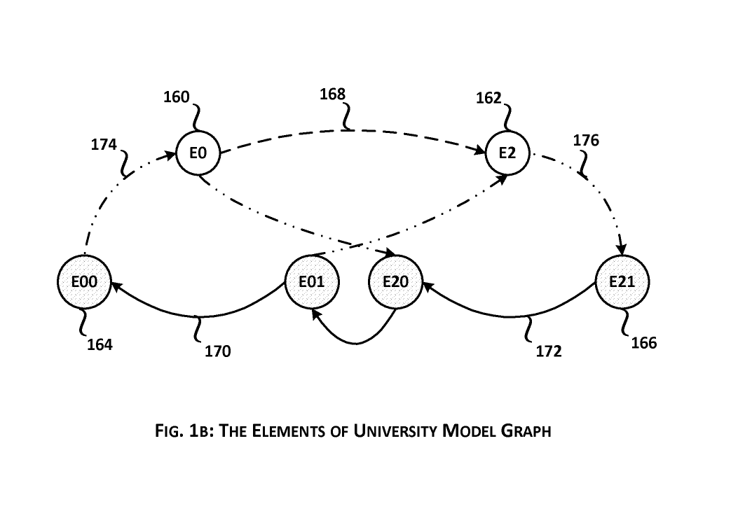

FIG. 1 provides an overview of EI Analysis System. The system (100) allows for what-if analysis and introspective analysis of a university and the means to achieve the same is as follows: to analyze the what-if request, based on the request, appropriately modify the university model graph associated with the university, interpret the modified university model graph to generate appropriate recommendations. The system takes a What-If request as input and generates recommendations to achieve, say, greater operational efficiency based on the database comprising of UMG data (110).

FIG. 1a depicts an illustrative University Model Graph. 140 describes UMG as consisting of two main components: Entity Graph (142) and Entity-Instance Graph (144). Entity graph consists of entities of the university as its nodes and an abstract edge (146) or abstract link is a directed edge that connects two entities of the entity graph. Note that edge and link are used interchangeably. The weight associated with this abstract edge is the influence factor or influence value indicating nature and quantum of influence of the source entity on the destination entity. Again, influence factor and influence value are used interchangeably. Similarly, the nodes in the entity-instance graph are the entity instances and the edge (148) or the link between two entity-instances is a directed edge and the weight associated with the edge indicates the nature and quantum of influence of the source entity-instance on the destination entity-instance.

FIG. 1b provides the elements of a University Model Graph. The fundamental elements are nodes and edges. There are two kinds of nodes: Abstract nodes (160 and 162) and Nodes (164 and 166); There are three kinds of directed edges or links: Abstract links (168), links (170 and 172), and semi- abstract links (174 and 176). As part of the modeling, the abstract nodes are mapped onto entities and nodes are mapped onto the instances of the entities; Each node is associated with an entity-specific instantiated model and a node score that is a value between 0 and 1 is based on the entity-specific instantiated model; This score is called as Base Score; the weight associated with an abstract link corresponds to an entity influence value (EI-Value), the weight associated with a semi-abstract link corresponds to either an entity-entity-instance influence value (EIEI-Value) or an entity-instance-entity influence value (IEEI-Value), and finally, the weight associated with a link corresponds to an entity-instance influence value (I-Value). Note that edges and links are used interchangeably. Further, each entity is associated with a model and an instance of an entity is associated with a base score and an instantiated model, wherein the base score is computed based on the associated instantiated model and denotes the assessment of the entity instance. The weight associated with a directed edge indicates the nature and quantum of influence of the source node on the destination node and is a value between −1 and +1; This weight is called as Influence Factor.

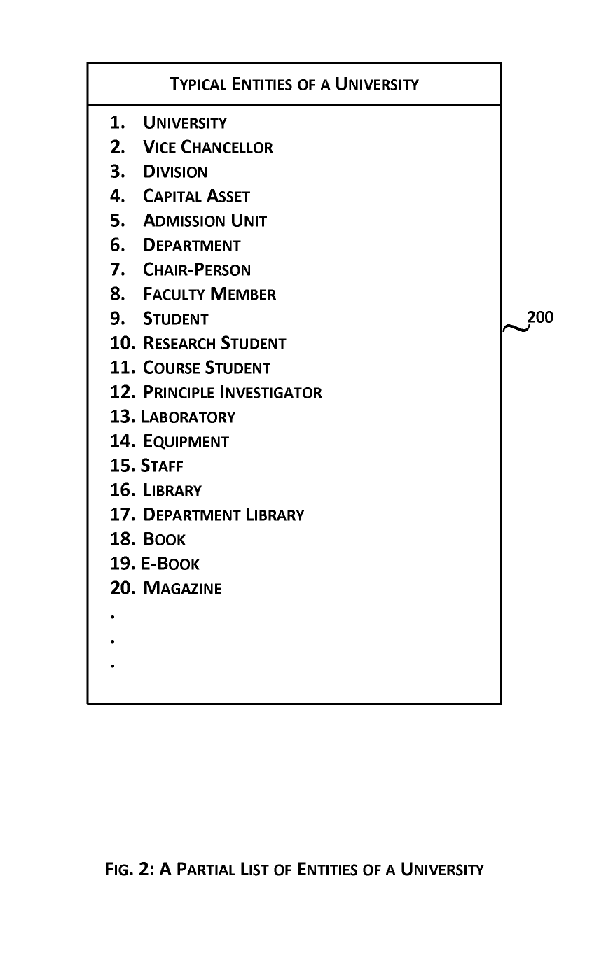

FIG. 2 depicts a partial list of entities of a university. Note that a deep domain analysis would uncover several more entities and also their relationship with the other entities (200). For example, RESEARCH STUDENT is a STUDENT who is a part of a DEPARTMENT and works with a FACULTY MEMBER in a LABORATORY using some EQUIPMENT, the DEPARTMENT LIBRARY, and the LIBRARY.

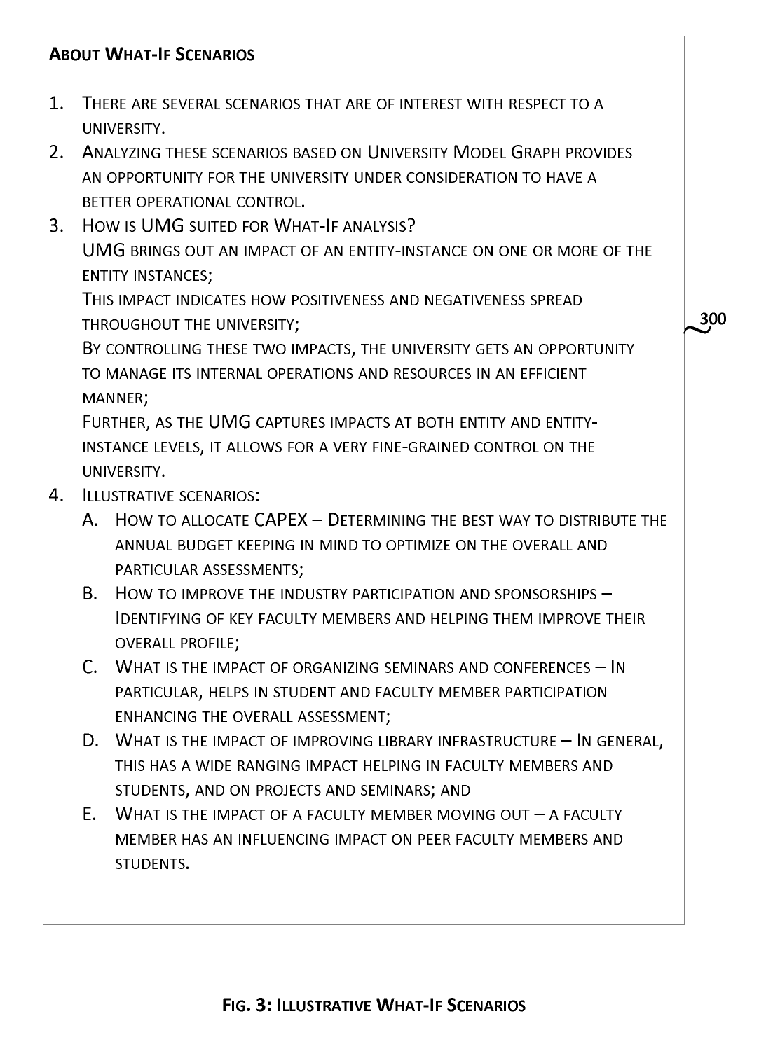

FIG. 3 provides illustrative What-If Scenarios.

About What-If Scenarios (300):
1. There are several scenarios that are of interest with respect to a university.
2. Analyzing these scenarios based on University Model Graph provides an opportunity for the university under consideration to have a better operational control.
3. How is UMG suited for What-If analysis?
   UMG brings out an impact of an entity-instance on one or more of the entity instances; This impact indicates how positiveness and negativeness spread throughout the university;
   By controlling these two impacts, the university gets an opportunity to manage its internal operations and resources in an efficient manner;
   Further, as the UMG captures impacts at both entity and entity-instance levels, it allows for a very fine-grained control on the university.
4. Illustrative scenarios:
   A. How to allocate CAPEX—Determining the best way to distribute the annual budget keeping in mind to optimize on the overall and particular assessments;
   B. How to improve the industry participation and sponsorships—Identifying of key faculty members and helping them improve their overall profile;
   C. What is the impact of organizing seminars and conferences—In particular, helps in student and faculty member participation enhancing the overall assessment;
   D. What is the impact of improving library infrastructure—In general, this has a wide ranging impact helping in faculty members and students, and on projects and seminars; and
   E. What is the impact of a faculty member moving out—a faculty member has an influencing impact on peer faculty members and students.

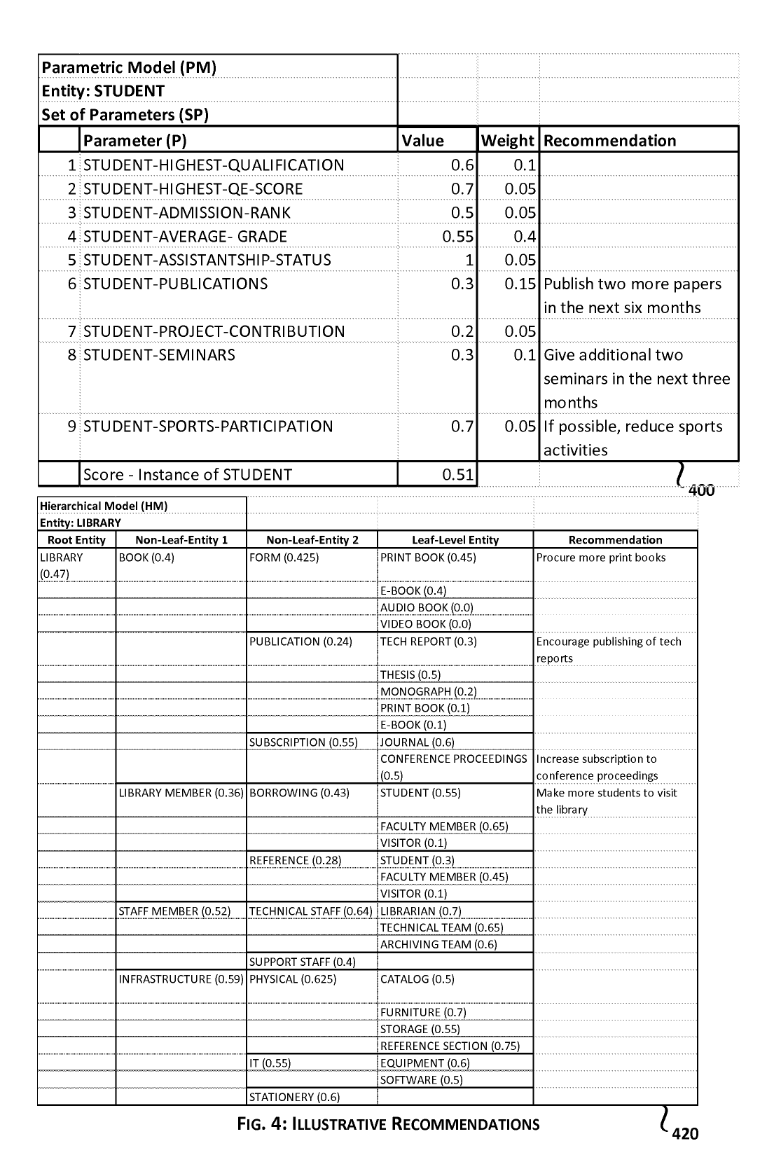

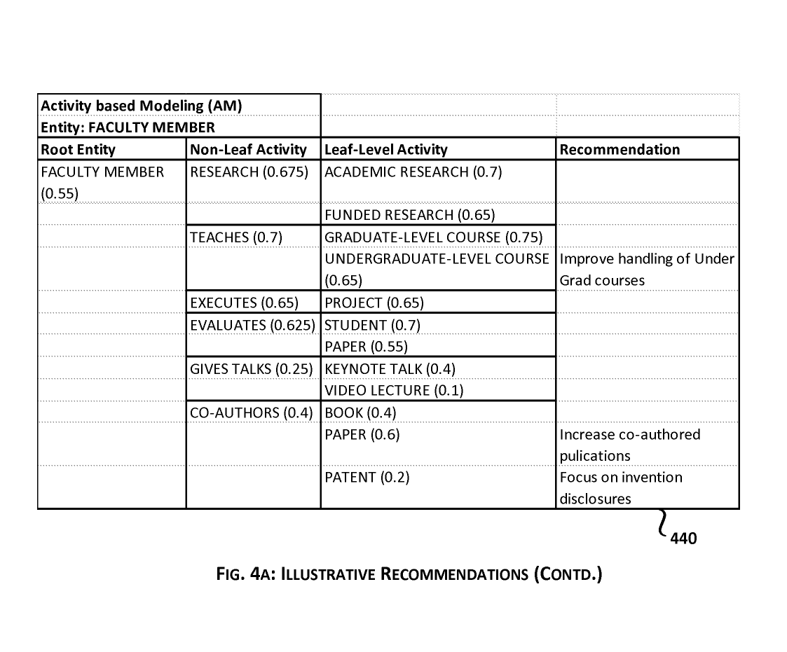

FIG. 4 provides illustrative Recommendations.

400 provides an illustrative parametric model of STUDENT entity. Note that the generated recommendations are based on parameter values where there seems to be a scope for improvement. The computations are illustrative in nature with the overall score arrived based on the weighted summation.

Similarly, 420 provides a few recommendations based on a hierarchical model associated with LIBRARY entity. Please note that the computations are for illustrative purposes and combined as a weighted summation at each level in the hierarchy.

FIG. 4A provides additional illustrative Recommendations.

Again, 440 provides a few recommendations based on an activity based model associated with FACULTY MEMBER entity. Please note that the computations are for illustrative purposes and combined as a weighted summation at each level in the activity hierarchy.

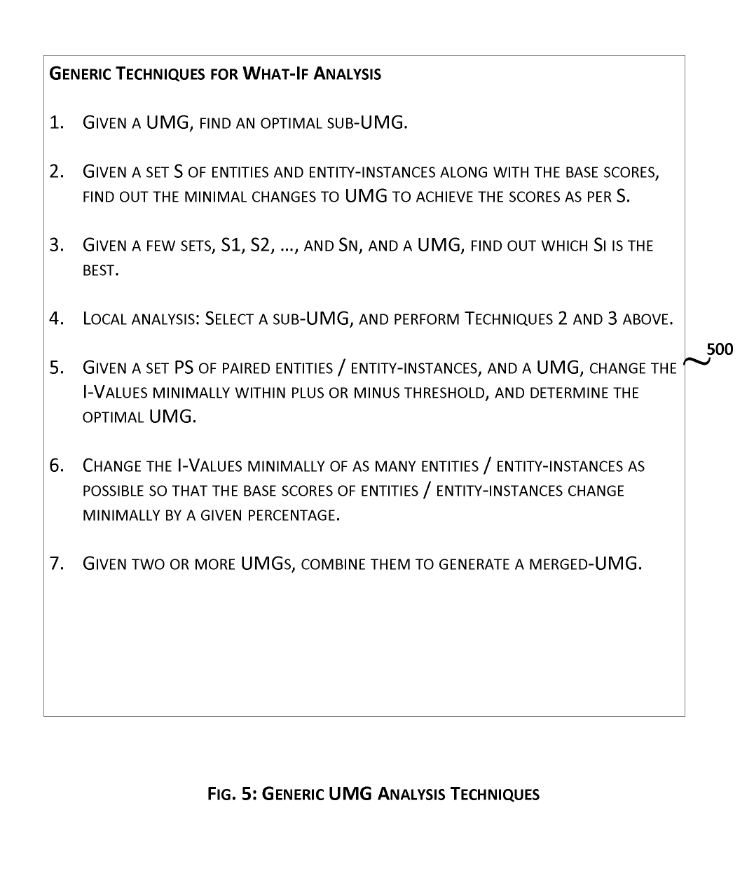

FIG. 5 provides an overview of Generic UMG Analysis Techniques.

Means for (analysis of a what-if request) Generic Techniques for What-If Analysis (500):
1. Given a UMG, find an optimal sub-UMG.
2. Given a set S of entities and entity-instances along with the base scores, find out the minimal changes to UMG to achieve the scores as per S.
3. Given a few sets, S1, S2, . . . , and Sn, and a UMG, find out which Si is the best.
4. Local analysis: Select a sub-UMG, and perform Techniques 2 and 3 above.
5. Given a set PS of paired entities/entity-instances, and a UMG, change the I-Values minimally within plus or minus threshold, and determine the optimal UMG.
6. Change the I-Values minimally of as many entities/entity-instances as possible so that the base scores of entities/entity-instances change minimally by a given percentage.
7. Given two or more UMGs, combine them to generate a merged-UMG.

These techniques play an important role in the analysis and processing of a what-if request.

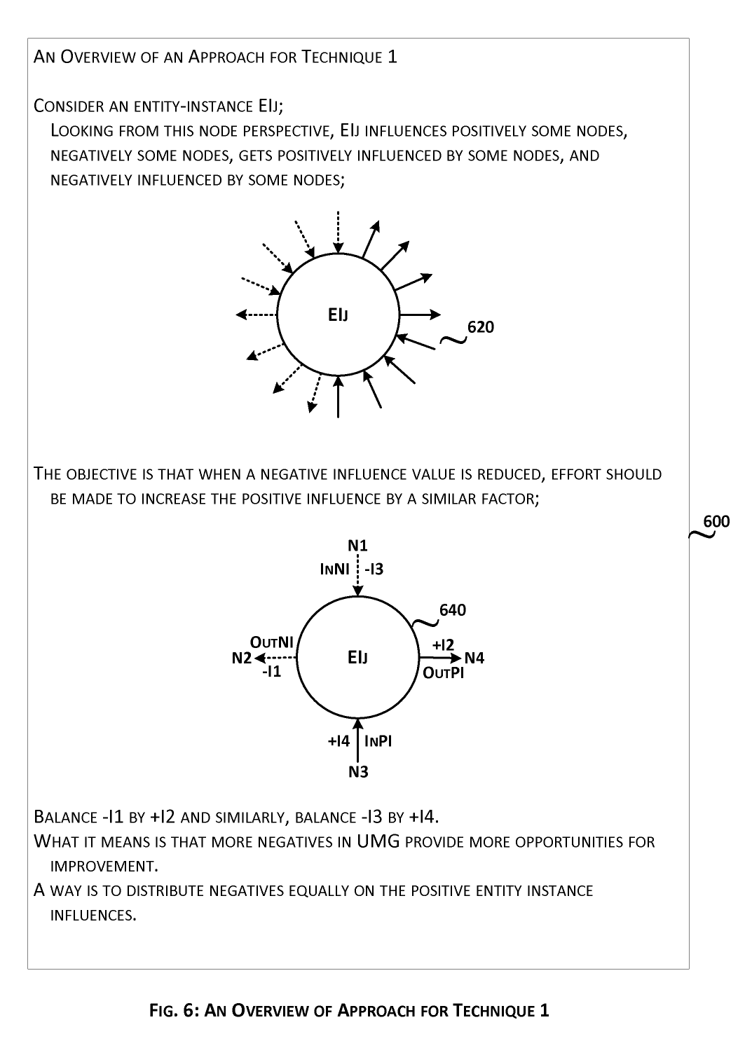

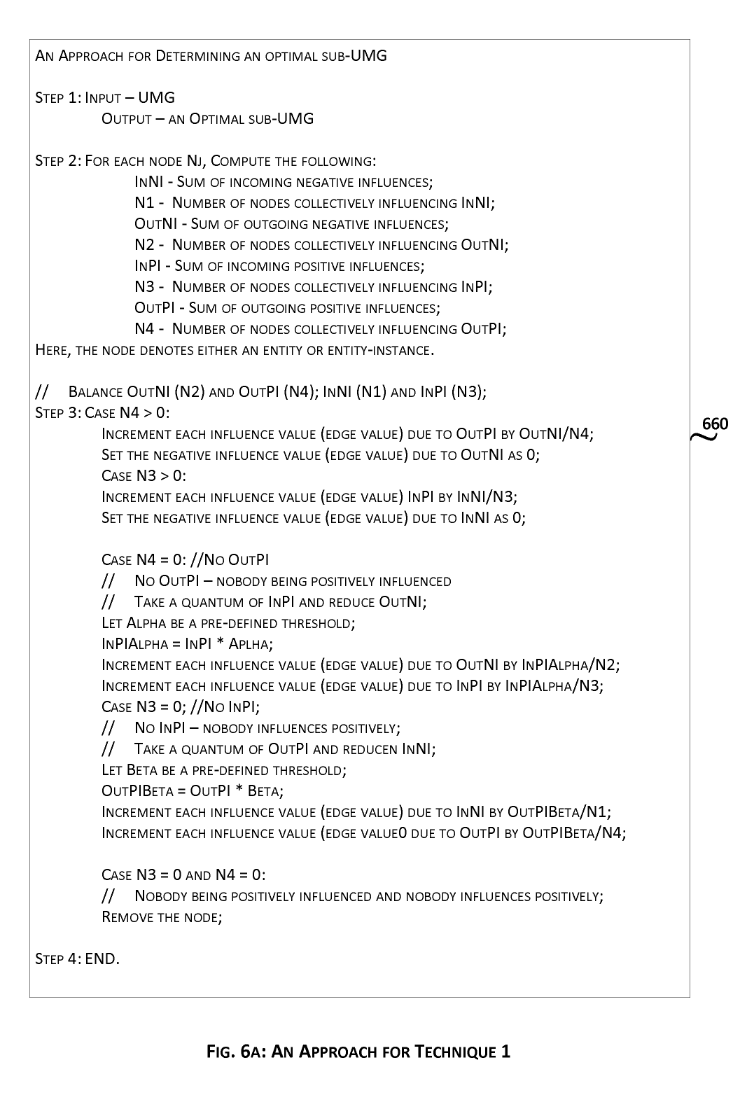

FIG. 6 provides an overview of Approach for Technique 1.

Means for an Overview of an Approach for Technique 1 (600):

Consider an entity-instance EIj;

Looking from this node perspective, EIj influences positively some nodes, negatively some nodes, gets positively influenced by some nodes, and negatively influenced by some nodes;

As depicted in 620, the node EIj has influences shown by arrow marks: Dotted incoming arrows indicate negative incoming influences, dotted outgoing arrows indicate negative outgoing influences, thick incoming arrows indicate positive incoming influences, and thick outgoing arrows indicate positive outgoing influences.

The objective is that when a negative influence value is reduced, effort should be made to increase the positive influence by a similar factor.

As described above, there are four distinct cumulative influence values (640): N1 nodes negatively influence EIj with an aggregated value of InNI and this value is denoted by −I3; Similarly, EIj influences N2 nodes negatively with an aggregated value of OutNI and this value is denoted by −I1; N3 nodes positively influence EIj with an aggregated value of InPI and this value is denoted by +I4; and, EIj influences N4 nodes positively with an aggregated value of OutPI and this value is denoted by +I2.

Balance −I1 by +I2 and similarly, balance −I3 by +I4.

What it means is that more negatives in UMG provide more opportunities for improvement. A way is to distribute negatives equally on the positive entity instance influences.

FIG. 6A provides an Approach for Technique 1.

Means for an approach for determining an optimal sub-UMG (660):

Step 1: Input—UMG
Output—an Optimal sub-UMG

Step 2: For each node Nj, Compute the following:
InNI—Sum of incoming negative influences;
N1—Number of nodes collectively influencing InNI;
OutNI—Sum of outgoing negative influences;
N2—Number of nodes collectively influencing OutNI;
InPI—Sum of incoming positive influences;
N3—Number of nodes collectively influencing InPI;
OutPI—Sum of outgoing positive influences;
N4—Number of nodes collectively influencing OutPI;

Here, the node denotes either an entity or entity-instance.

// Balance OutNI (N2) and OutPI (N4); InNI (N1) and InPI (N3);

Step 3: Case N4>0:
Increment each influence value (edge value) due to OutPI by OutNI/N4;
Set the negative influence value (edge value) due to OutNI as 0;

Case N3>0:
Increment each influence value (edge value) InPI by InNI/N3;
Set the negative influence value (edge value) due to InNI as 0;
Case N4=0://No OutPI
// No OutPI—nobody being positively influenced
// Take a quantum of InPI and reduce OutNI;
Let Alpha be a pre-defined threshold;
InPIAlpha=InPI*Alpha;
Increment each influence value (edge value) due to OutNI by InPIAlpha/N2;
Increment each influence value (edge value) due to InPI by InPIAlpha/N3
Case N3=0; //No InPI;
// No InPI—nobody influences positively;
// Take a quantum of OutPI and reducen InNI;
Let Beta be a pre-defined threshold;
OutPIBeta=OutPI*Beta;
Increment each influence value (edge value) due to InNI by OutPIBeta/N1;
Increment each influence value (edge value0 due to OutPI by OutPIBeta/N4;
Case N3=0 and N4=0:
// Nobody being positively influenced and nobody influences positively;
Remove the node;

Step 4: END.

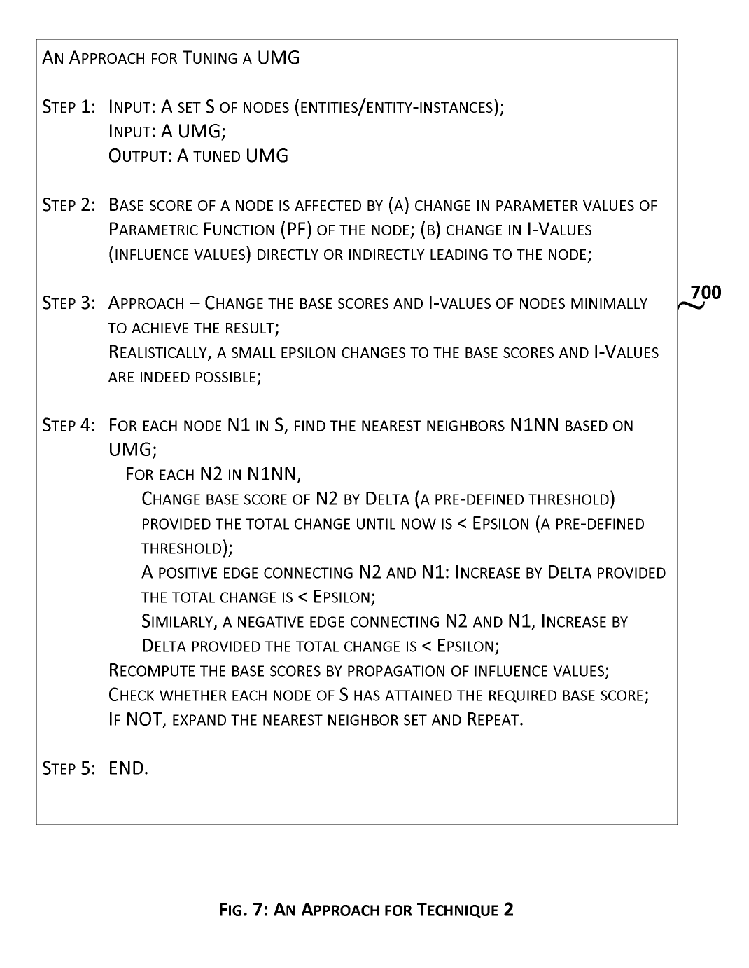

FIG. 7 provides an Approach for Technique 2.

Means for an Approach for Tuning a UMG (700):

Step 1: Input: A set S of nodes (entities/entity-instances);
Input: A UMG;
Output: A tuned UMG

Step 2: Base score of a node is affected by (a) change in parameter values of Parametric Function (PF) of the node; (b) change in I-Values (influence values) directly or indirectly leading to the node;

Step 3: Approach—Change the base scores and I-values of nodes minimally to achieve the result;
Realistically, a small epsilon changes to the base scores and I-Values are indeed possible;

Step 4: For each node N1 in S, find the nearest neighbors N1NN based on UMG;
For each N2 in N1NN,
Change base score of N2 by Delta (a pre-defined threshold) provided the total change until now is <Epsilon (a pre-defined threshold);
A positive edge connecting N2 and N1: Increase by Delta provided the total change is <Epsilon;
Similarly, a negative edge connecting N2 and N1, Increase by Delta provided the total change is <Epsilon;
Recompute the base scores by propagation of influence values;
Check whether each node of S has attained the required base score;
If NOT, expand the nearest neighbor set and Repeat.

Step 5: END.

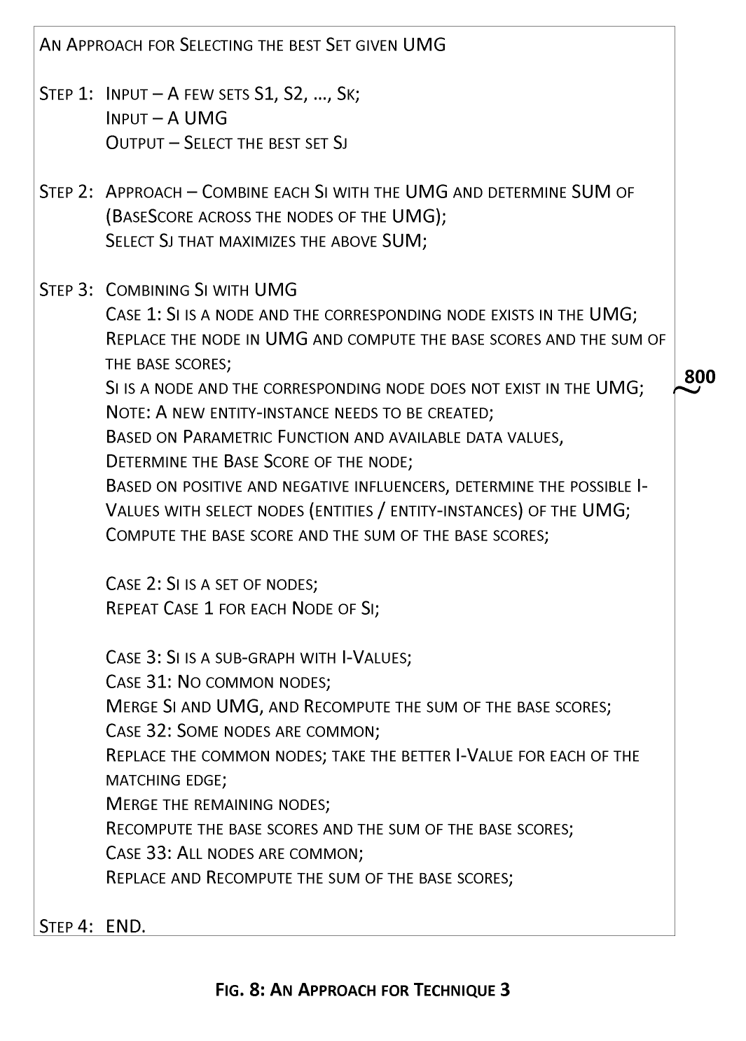

FIG. 8 provides an Approach for Technique 3.

Means for an Approach for Selecting the best Set given UMG (800):

Step 1: Input—A few sets S1, S2, . . . , Sk;
Input—A UMG
Output—Select the best set Sj

Step 2: Approach—Combine each Si with the UMG and determine SUM of (BaseScore across the nodes of the UMG);
Select Sj that maximizes the above SUM;

Step 3: Combining Si with UMG
Case 1: Si is a node and the corresponding node exists in the UMG;
Replace the node in UMG and compute the base scores and the sum of the base scores;
Si is a node and the corresponding node does not exist in the UMG;
Note: A new entity-instance needs to be created;
Based on Parametric Function and available data values,
Determine the Base Score of the node;
Based on positive and negative influencers, determine the possible I-Values with select nodes (entities/entity-instances) of the UMG;
Compute the base score and the sum of the base scores;
Case 2: Si is a set of nodes;
Repeat Case 1 for each Node of Si;
Case 3: Si is a sub-graph with I-Values;
Case 31: No common nodes;
Merge Si and UMG, and Recompute the sum of the base scores;
Case 32: Some nodes are common;
Replace the common nodes; take the better I-Value for each of the matching edge;
Merge the remaining nodes;
Recompute the base scores and the sum of the base scores;
Case 33: All nodes are common;
Replace and Recompute the sum of the base scores;

Step 4: END.

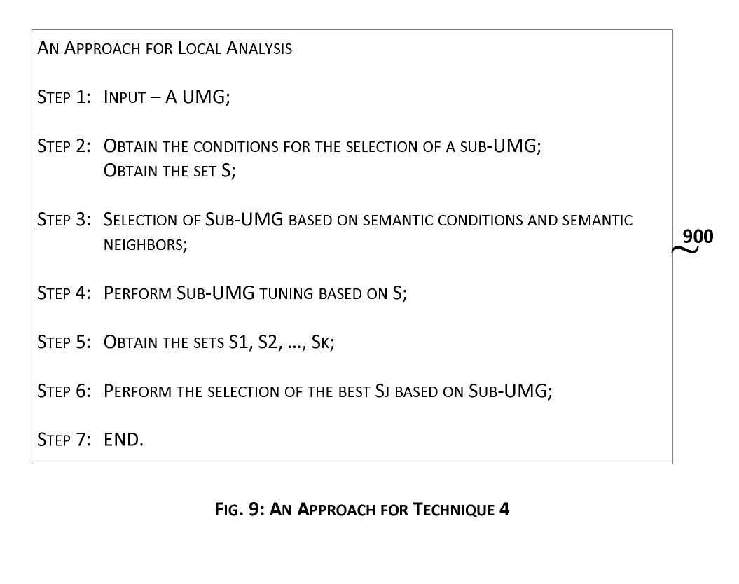

FIG. 9 provides an Approach for Technique 4.

Means for an Approach for Local Analysis (900):

Step 1: Input—A UMG;

Step 2: Obtain the conditions for the selection of a sub-UMG;
Obtain the set S;

Step 3: Selection of Sub-UMG based on semantic conditions and semantic neighbors;
For example, consider the entity FACULTY MEMBER; for each such entity, define semantic neighbors; and continue in the same manner; As an illustration, FACULTY MEMBER, all courses offered by FACULTY MEMBER (nearest neighbors NNs), STUDENTS who have enrolled for each course, LAB where FACULTY MEMBER is an investigator, FUNDS allocated to LAB, FACULTY MEMBER co-working in LAB, . . .

Step 4: Perform Sub-UMG tuning based on 5;

Step 5: Obtain the sets S1, S2, . . . , Sk;

Step 6: Perform the selection of the best Sj based on Sub-UMG;

Step 7: END.

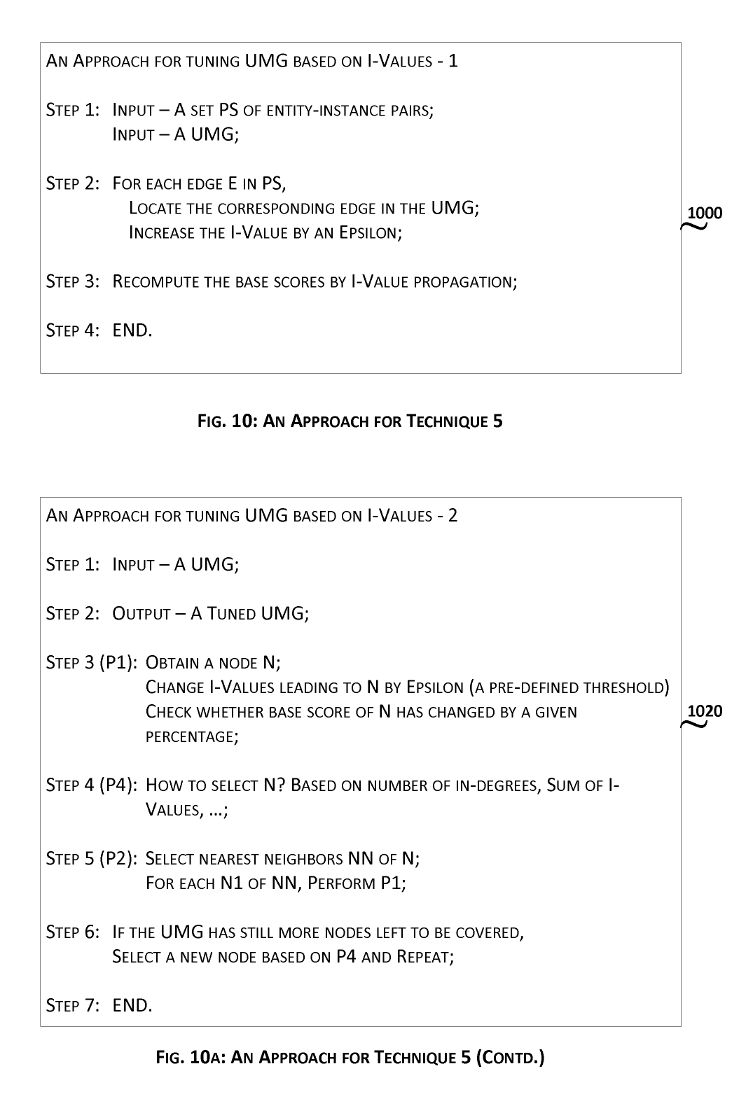

FIG. 10 provides an Approach for Technique 5.

Means for an Approach for tuning UMG based on I-Values—1 (1000):

Step 1: Input—A set PS of entity-instance pairs;
Input—A UMG;

Step 2: For each edge E in PS,
Locate the corresponding edge in the UMG;
Increase the I-Value by an Epsilon;

Step 3: Recompute the base scores by I-Value propagation;

Step 4: END.

FIG. 10A provides additional information on Approach for Technique 5.

Means for an Approach for tuning UMG based on I-Values—2 (1020):

Step 1: Input—A UMG;

Step 2: Output—A Tuned UMG;

Step 3 (P1): Obtain a node N;
Change I-Values leading to N by Epsilon (a pre-defined threshold);
Check whether base score of N has changed by a given percentage;

Step 4 (P4): How to select N? Based on number of in-degrees, Sum of I-Values, . . . ;

Step 5 (P2): Select nearest neighbors NN of N;
For each N1 of NN, Perform P1;

Step 6: If the UMG has still more nodes left to be covered,
Select a new node based on P4 and Repeat;

Step 7: END.

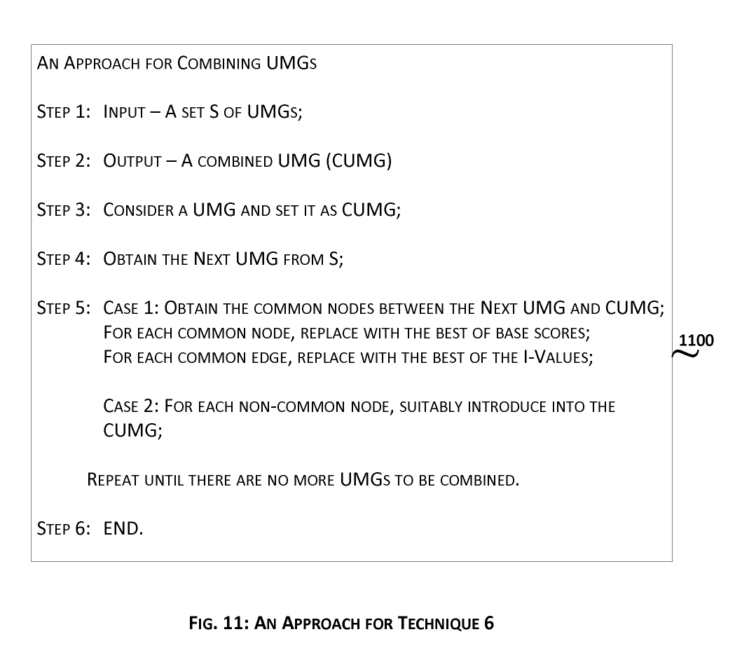

FIG. 11 provides an Approach for Technique 6.

Means for an Approach for Combining UMGs (1100):

Step 1: Input—A set S of UMGs;

Step 2: Output—A combined UMG (CUMG)

Step 3: Consider a UMG and set it as CUMG;

Step 4: Obtain the Next UMG from S;

Step 5: Case 1: Obtain the common nodes between the Next UMG and CUMG;
For each common node, replace with the best of base scores;
For each common edge, replace with the best of the I-Values;
Case 2: For each non-common node, suitably introduce into the CUMG;
Repeat until there are no more UMGs to be combined.

Step 6: END.

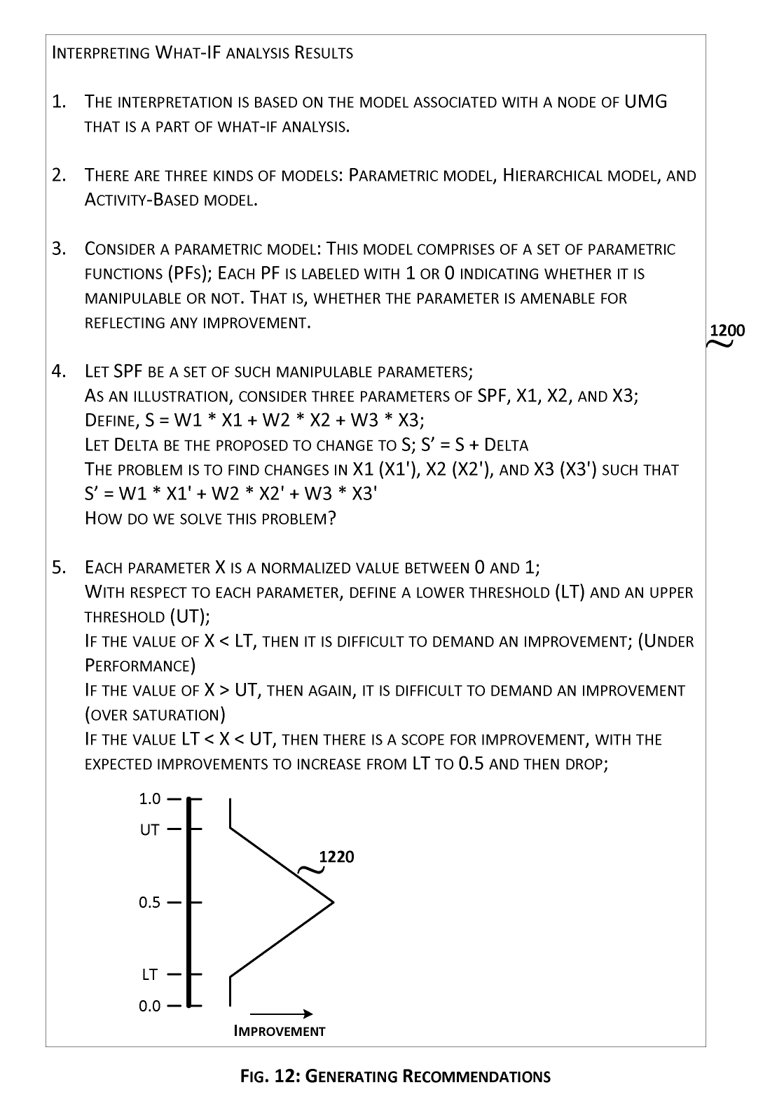

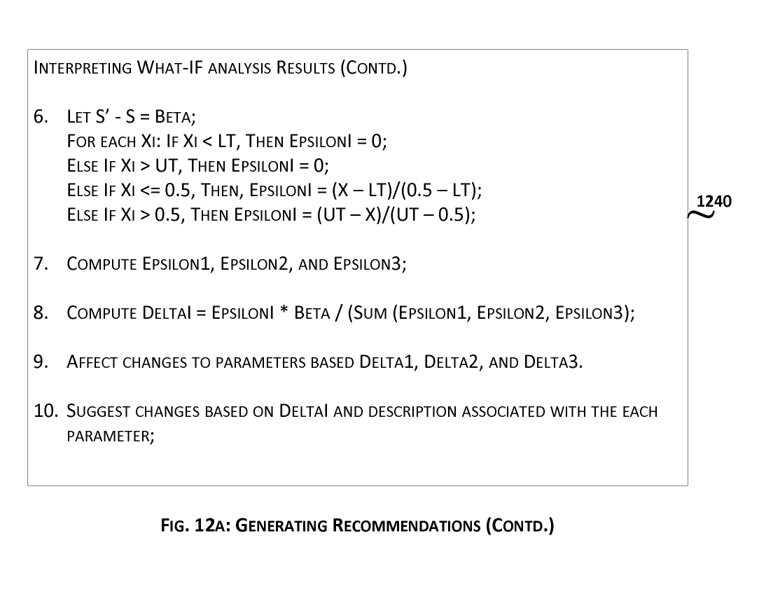

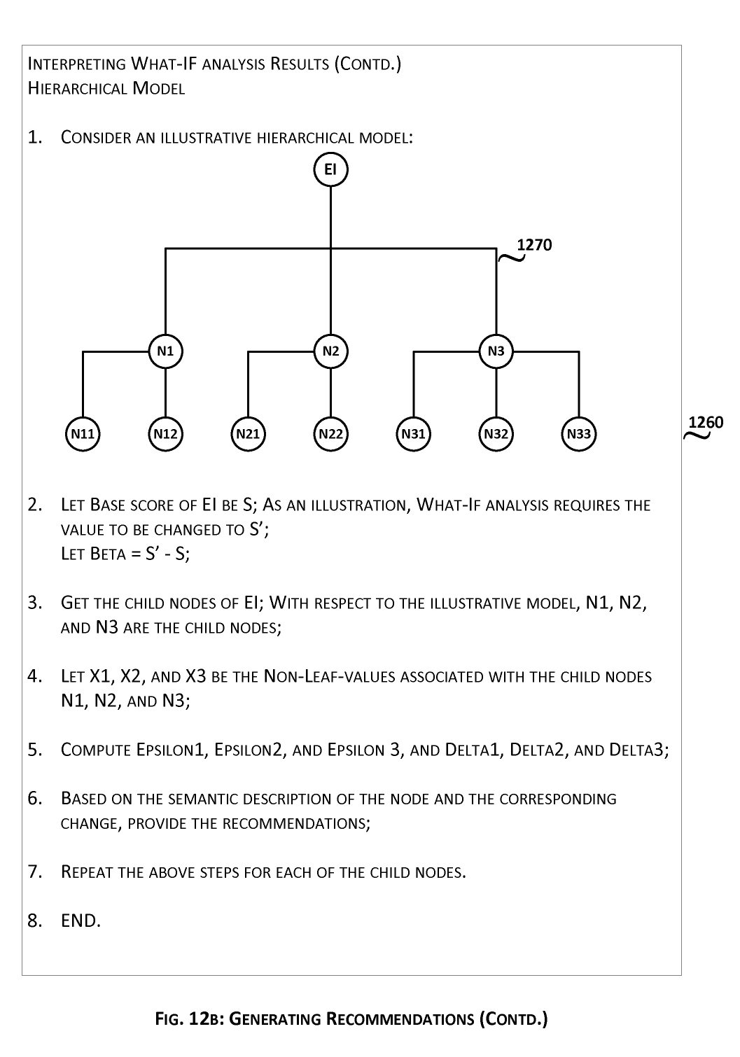

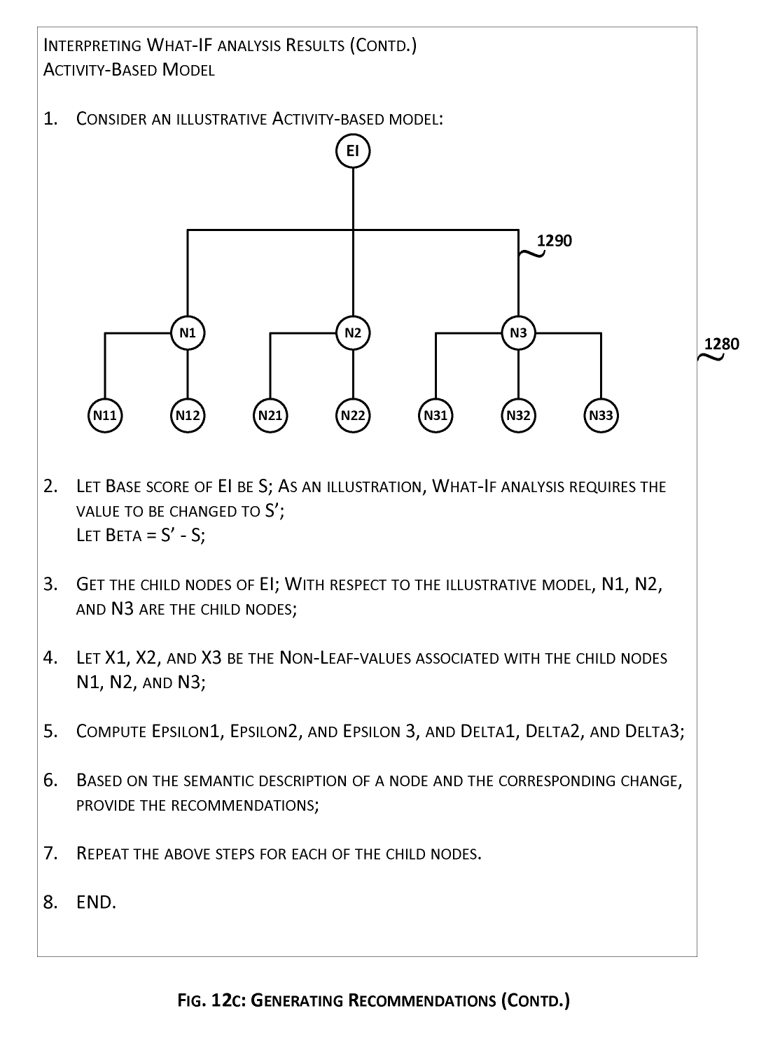

FIG. 12 provides an overview of Generating Recommendations.

Interpreting What-IF analysis Results (1200):

Means and an approach for generating recommendations based on Parametric Model:

1. The interpretation is based on the model associated with a node of UMG that is a part of what-if analysis.

2. There are three kinds of models: Parametric model, Hierarchical model, and Activity-Based model.

3. Consider a parametric model: This model comprises of a set of parametric functions (PFs); Each PF is labeled with 1 or 0 indicating whether it is manipulable or not. That is, whether the parameter is amenable for reflecting any improvement.

4. Let SPF be a set of such manipulable parameters;
As an illustration, consider three parameters of SPF, X1, X2, and X3;
Define, S=W1*X1+W2*X2+W3*X3;
Let Delta be the proposed to change to S; S′=S+Delta
The problem is to find changes in X1 (X1′), X2 (X2′), and X3 (X3′) such that
S′=W1*X1′+W2*X2′+W3*X3′
How do we solve this problem?

5. Each parameter X is a normalized value between 0 and 1;
With respect to each parameter, define a lower threshold (LT) and an upper threshold (UT) (1220);
If the value of X<LT, then it is difficult to demand an improvement; (Under Performance)
If the value of X>UT, then again, it is difficult to demand an improvement (Over Saturation)
If the value LT<X<UT, then there is a scope for improvement, with the expected improvements to increase from LT to 0.5 and then drop;

FIG. 12A provides additional information related to Generating of Recommendations.

Interpreting What-IF analysis Results (Contd.) (1240):

Means and an approach for generating recommendations based on Parametric Model (Contd.):

6. Let S′−S=Beta;
For each Xi: If Xi<LT, Then EpsilonI=0;
Else If Xi>UT, Then EpsilonI=0;
Else If Xi<=0.5, Then, EpsilonI=(X−LT)/(0.5−LT);
Else If Xi>0.5, Then EpsilonI=(UT−X)/(UT−0.5);

7. Compute Epsilon1, Epsilon2, and Epsilon3;

8. Compute DeltaI=EpsilonI*Beta/(Sum (Epsilon1, Epsilon2, Epsilon3);

9. Affect changes to parameters based Delta1, Delta2, and Delta3.

10. Suggest changes based on Delta! and description associated with the each parameter;

FIG. 12B provides more information related to Generating of Recommendations.

Interpreting What-IF analysis Results (Contd.) (1260):

Means and an approach for generating recommendations based on Hierarchical Model:
1. Consider an illustrative hierarchical model (1270):
2. Let Base score of EI be S; As an illustration, What-If analysis requires the value to be changed to S′;
Let Beta=S′−5;

3. Get the child nodes of EI; With respect to the illustrative model, N1, N2, and N3 are the child nodes;

4. Let X1, X2, and X3 be the Non-Leaf-values associated with the child nodes N1, N2, and N3;

5. Compute Epsilon1, Epsilon2, and Epsilon 3, and Delta1, Delta2, and Delta3;

6. Based on the semantic description of a node and the corresponding change, provide the recommendations;

7. Repeat the above steps for each of the child nodes.

8. END.

FIG. 12C provides further more information related to Generating of Recommendations.

Interpreting What-IF analysis Results (Contd.) (1280):

Means and an approach for generating recommendations based on Activity-Based Model:
1. Consider an illustrative Activity-based model (1290):
2. Let Base score of EI be S; As an illustration, What-If analysis requires the value to be changed to S′;
Let Beta=S′−S;

3. Get the child nodes of EI; With respect to the illustrative model, N1, N2, and N3 are the child nodes;

4. Let X1, X2, and X3 be the Non-Leaf-values associated with the child nodes N1, N2, and N3;

5. Compute Epsilon1, Epsilon2, and Epsilon 3, and Delta1, Delta2, and Delta3;

6. Based on the semantic description of a node and the corresponding change, provide the recommendations;

7. Repeat the above steps for each of the child nodes.

8. END.

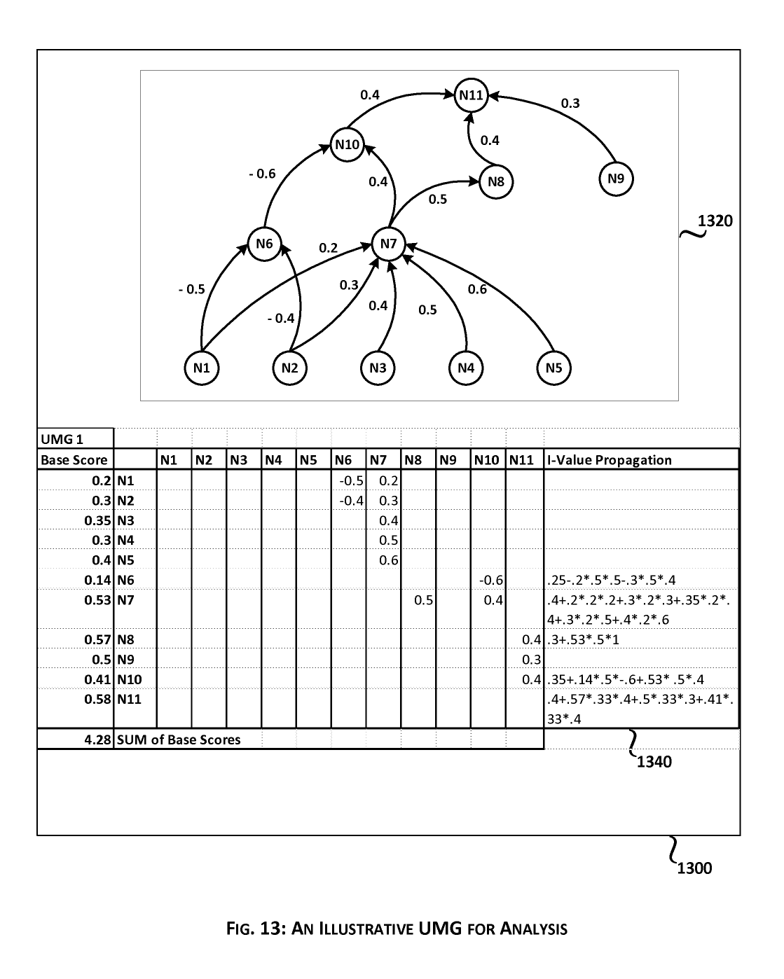

FIG. 13 provides an illustrative UMG for Analysis.

The illustrated UMG (1300) is shown in two forms: A graph based depiction (1320) displays how the various nodes (that stand for entities/entity-instances) N1, N2, . . . , N11 are interconnected; further, the edges are indicated with the illustrative influence values that are a value between −1 and +1. An equivalent representation is in the form of adjacency matrix (1340). In this representation, the element values depict the influence values as shown. Further, the base score associated with each of the nodes is also indicated under the column “Base Score.” The depicted UMG is in its stable form after the influence values have been propagated. An illustrative propagation is shown wherein the influence values of the child nodes along with base scores are used in arriving at the updated base score of a parent node.

FIG. 13A provides an illustrative Analysis Result related to Tuning of UMG. 1360 depicts the result of the illustrative analysis. In tuning, an attempt is made to reduce the negative influence values associated with N1-N6, N2-N6, and N6-N10. The base scores are appropriately recomputed based on the changed influence values leading to the UMG that is better (operationally, more efficient) as depicted by the SUM of the base scores (4.56 as compared with 4.28).

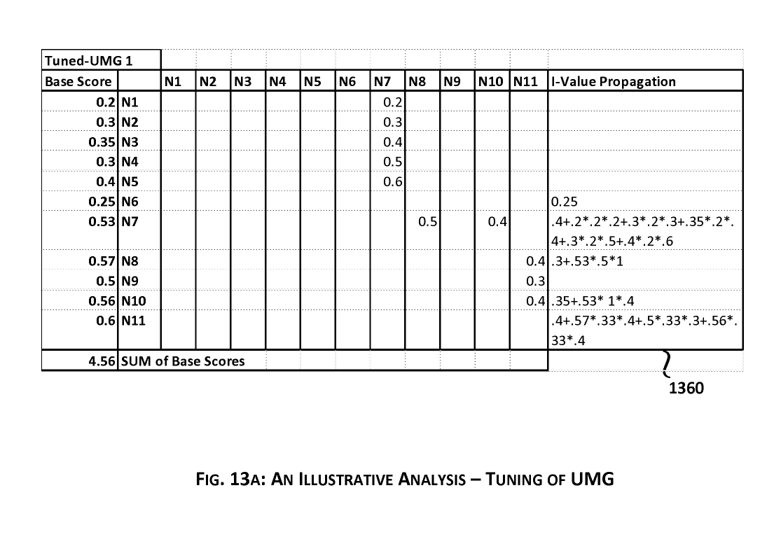

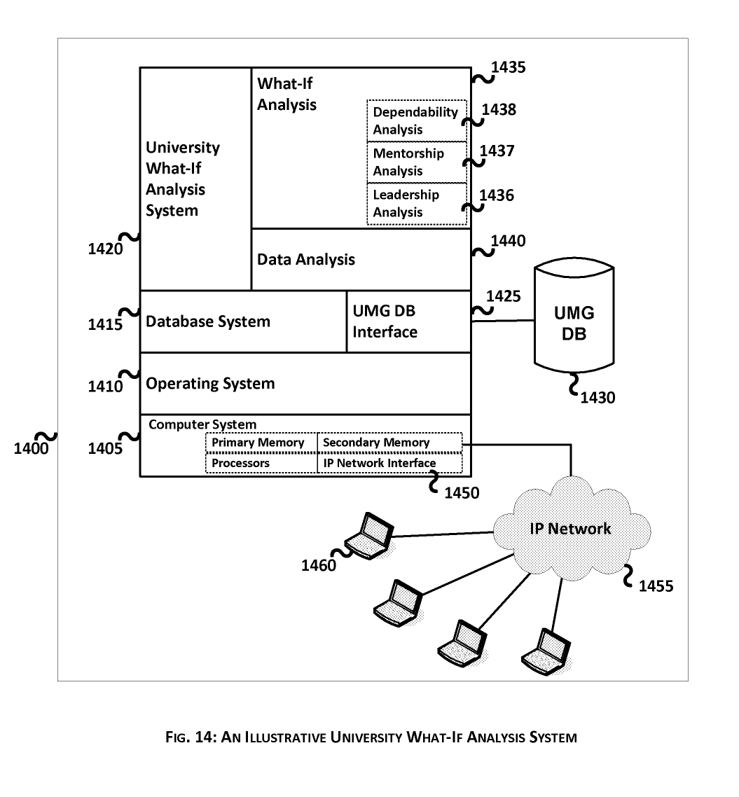

FIG. 14 provides an illustrative elaboration (1400) of University What-If System. In a preferred embodiment, the University What-If Analysis System (1420) is realized on a computer system (1405) with several processors, primary memory units, secondary memory units, and network interfaces, and with an operating system (1410) and a database system (1415). The database system in particular comprises of a component University Model Graph (UMG) DB (database) Interface (1425) to help access University Model Graph (UMG) database (1430). As depicted in the figure, the University What-If Analysis System comprises of two key components, namely, What-If Analysis Component (1435) and Data Analysis Component (1440). The Data Analysis component helps in retrieving and analyzing of the required data elements from the UMG Database while the What-If Analysis component helps undertake analyses of student data in UMG database for nurturing students to excel in leadership, mentorship, and dependability, and this is achieved using three analysis sub-components related to Leadership (1436), Mentorship (1437),and Dependability (1438). Note that in a preferred embodiment, the University What-If Analysis System analyzes the data associated with a set of students of a university to help them evolve in their leadership, mentorship, and dependability abilities by suggesting to transition from a prevailing state to the next state.

The IP Network Interface (1450) is used to connect the computer system to an Internet Protocol (IP) Network (1455) so that several users (1460) can connect and interact with the University What-If Analysis System through the Internet or an intranet.

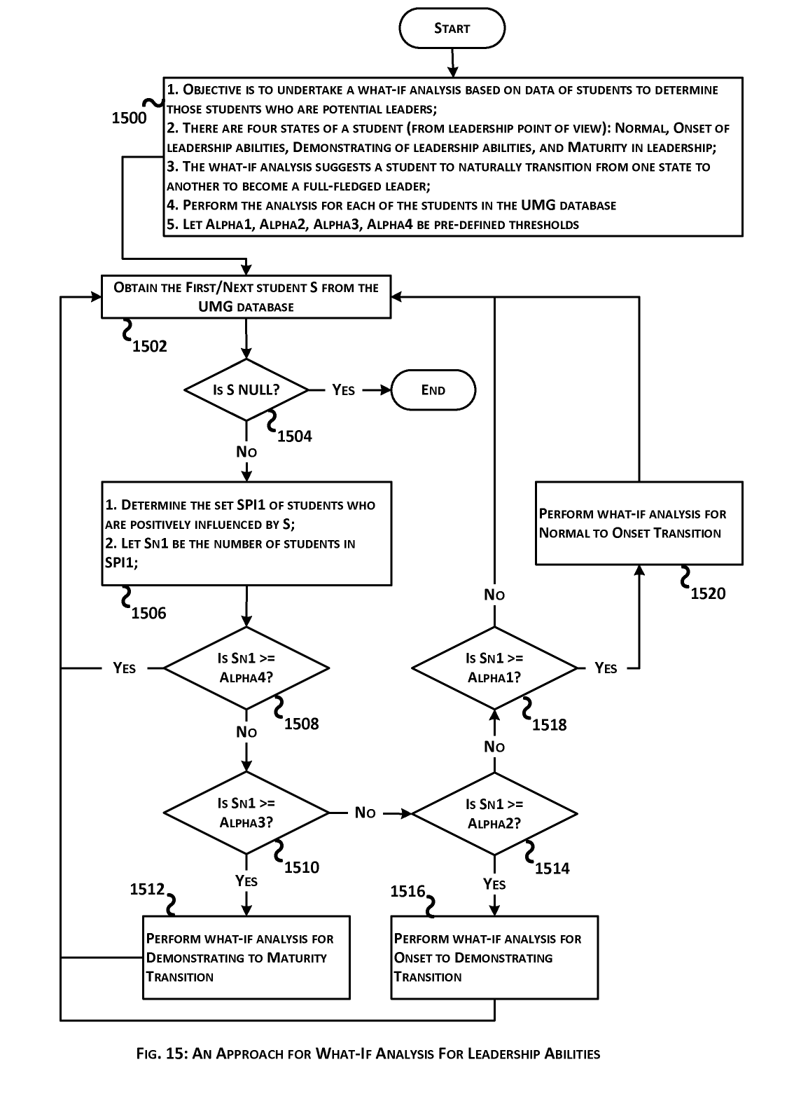

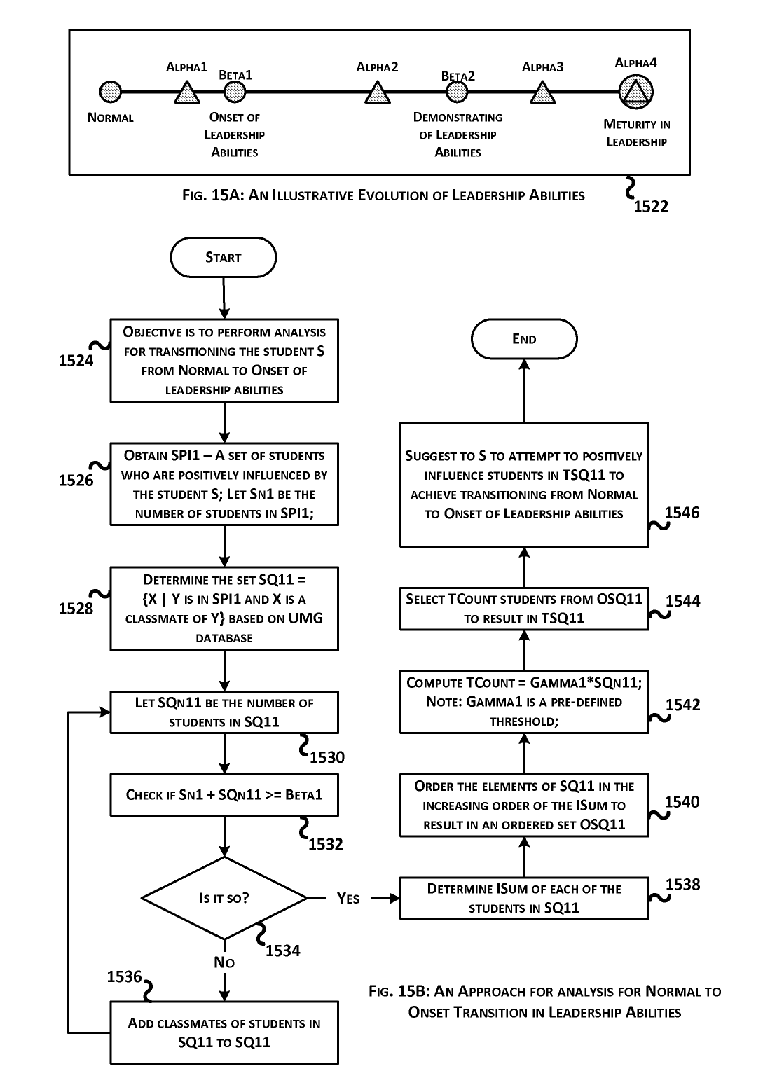

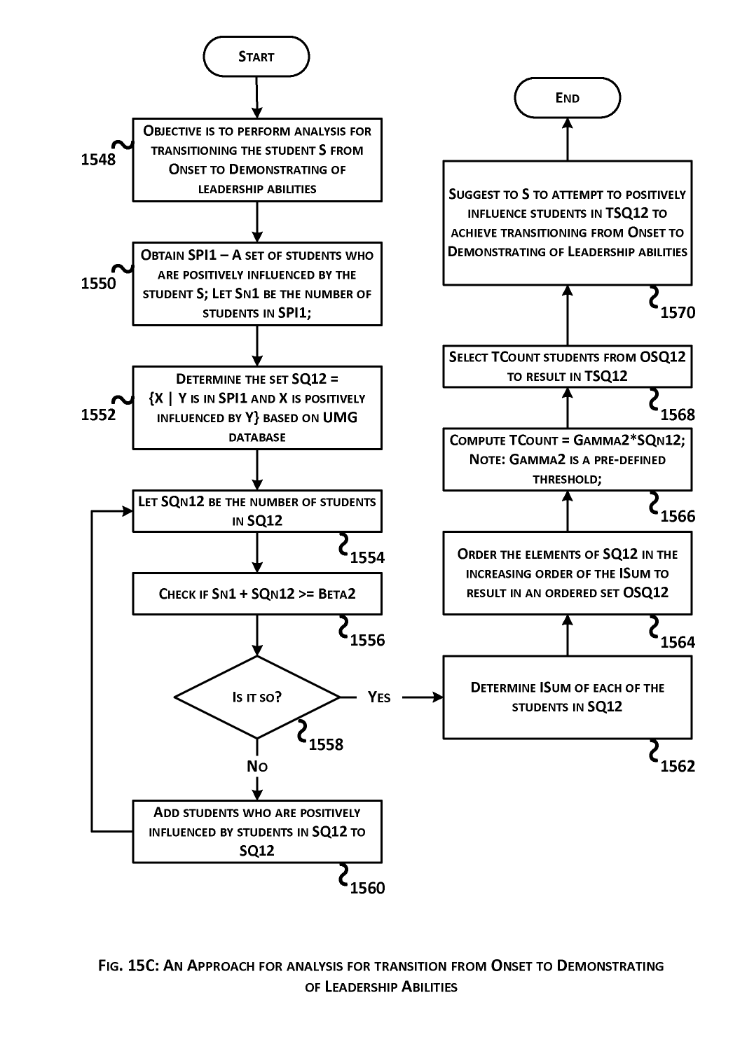

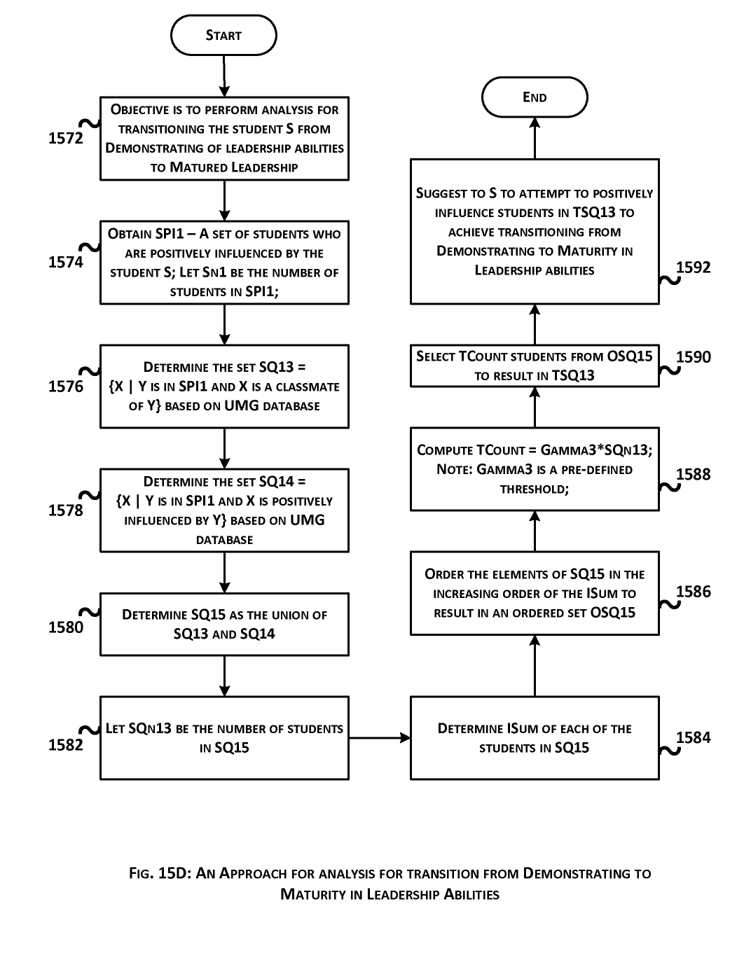

FIG. 15 depicts an approach for What-If Analysis for Leadership abilities.

The objective is to undertake a what-if analysis based on data of students to determine those students who are potential leaders (1500). The analysis is to help determine what happens, from a leadership abilities point of view, if a student were to act in a particular manner.

There are four states of a student (from leadership point of view):

Normal: As the name suggests, the student is yet to display any leadership traits;

Onset of leadership abilities: This state indicates that the student has started showing their keenness to develop leadership skills;

Demonstrating of leadership abilities: This state indicates that the student has started demonstrating the leadership skill; and

Maturity in leadership: This final state of leadership indicates that the student indeed has developed matured leadership abilities.

The what-if analysis suggests a student to naturally transition from one state to another to become a full-fledged leader.

Perform the what-if analysis for each of the students in the UMG database to determine and suggest about their leadership abilities.

Let Alpha1, Alpha2, Alpha3, and Alpha4 be pre-defined thresholds.

Obtain the First/Next student S from the UMG database (1502).

If there are no more students to be processed (that is, S is NULL) (1504), then end.

Otherwise (1504), determine the set SPI1 of students who are positively influenced by S (1506).

Let Sn1 be the number of students in SPI1.

If Sn1>=Alpha4 (1508), then the student is in the matured leadership state and hence, no need to undertake any further what-if analysis. Proceed to Step 1502.

If it is not so (1508), check if Sn1>=Alpha3 (1510).

If it is so (1510), Perform what-if analysis for Demonstrating to Maturity Transition (1512) and proceed to Step 1502 to process other remaining students.

If it is not so (1510), check if Sn1>=Alpha2 (1514).

If it is so (1514), Perform what-if analysis for Onset to Demonstrating Transition (1516) and proceed to Step 1502 to process other remaining students.

If it is not so (1514), check if Sn1>=Alpha1 (1518).

If it is so (1518), Perform what-if analysis for Normal to Onset Transition (1520) and proceed to Step 1502 to process other remaining students.

If it is no so (1518), the student S is yet to show keenness in developing leadership abilities.

Proceed to Step 1502 to process other remaining students.

FIG. 15A provides an illustrative evolution of Leadership abilities.

The state of a leadership ability of the student S is determined based on the extent of positive influence on a set of students by S. The Step 1522 depicts how the extent of positive influence is related to the various states of leadership. For example, if the extent of positive influence is greater than or equal to Beta1, then it is concluded that the student S has displayed the Onset of leadership abilities. Observe that the student is nurtured towards this state when the extent of positive influence becomes greater than or equal to Alpha1. Similarly, the step depicts the relationship between the threshold values Alpha2, Beta2, Alpha3, and Alpha4, and the states of leadership, namely, Demonstrating of leadership abilities and Maturity in Leadership.

FIG. 15B provides an approach for the analysis for Normal to Onset transition in Leadership abilities. The objective is to perform analysis for transitioning the student S from Normal to Onset of leadership abilities (1524).

Obtain SPI1—a set of students who are positively influenced by the student S (1526).

Let Sn1 be the number of students in SPI1.

Determine the set SQ11={X|Y is in SPI1 and X is a classmate of Y} based on UMG database (1528). The requirement is to help the student S to progress into Onset state: This is done by suggesting how to expand the extent of positively influence. In a particular embodiment, this is achieved by determining the classmates of students who are positively influenced by S as the candidate students.

Let SQn11 be the number of students in SQ11 (1530).

Check if Sn1+SQn11>=Beta1 (1532).

If it is not so (1534), it is required further expand the candidate student set.

Add classmates of students in SQ11 to SQ11 (1536) and proceed to Step 1530.

If it is so (1534), it is possible to help S to progress towards Onset state of leadership and hence, proceed to Step 1538.

Determine ISum of each of the students in SQ11 (1538). Here, ISum (influence sum) of a student X is the sum of the influences (both positive and negative) directed at X by the other students of the university.

Order the elements of SQ11 in the increasing order of the ISum to result in an ordered set OSQ11 (1540). In order for the Student S to develop leadership skills, it is suggested to select the candidate students who have not been highly influenced and hence, the ordering is increasing in the ISum values.

Compute TCount (targeted count of students)=Gamma1*SQn11 (1542). Here, TCount is the number of candidate students to be targeted by the Student S for positively influencing them. Note that Gamma1 is a pre-defined threshold.

Select TCount students from OSQ11 to result in TSQ11 (1544).

Suggest to S to attempt to positively influence students in TSQ11 to achieve transitioning from Normal to Onset of Leadership abilities (1546). In due course of time, as S focuses on developing the leadership skills, the students in TSQ11 would be positively influenced by the student S.

FIG. 15C depicts an approach for the analysis for transition from Onset to Demonstrating of Leadership abilities.

The objective is to perform the analysis for transitioning the student S from Onset to Demonstrating of leadership abilities (1548).

Obtain SPI1—a set of students who are positively influenced by the student S (1550).

Let Sn1 be the number of students in SPI1.

Determine the set SQ12={X|Y is in SPI1 and X is positively influenced by Y} based on UMG database (1552). One of the additional ways to expand the extent of positive influence by the student S is to identify the possible candidate students by trying to positively influence students who are positively influenced by the students who are positively influenced by S.

Let SQn12 be the number of students in SQ12 (1554).

Check if Sn1+SQn12>=Beta2 (1556).

If it is not so (1558), then it is required further expand the candidate student set.

Add students who are positively influenced by students in SQ12 to SQ12 (1560) and proceed to Step 1554.

If it is so (1558), it is possible to help S to progress towards Demonstrating state of leadership and hence, proceed to Step 1562.

Determine ISum of each of the students in SQ12 (1562).

Order the elements of SQ12 in the increasing order of the ISum to result in an ordered set OSQ12 (1564).

Compute TCount (targeted count of students)=Gamma2*SQn12 (1566). Here, TCount is the number of candidate students to be targeted by the Student S for positively influencing them. Note that Gamma2 is a pre-defined threshold.

Select TCount students from OSQ12 to result in TSQ12 (1568).

Suggest to S to attempt to positively influence students in TSQ12 to achieve transitioning from Onset to Demonstrating of Leadership abilities (1570). In due course of time, as S focuses on developing the leadership skills, the students in TSQ12 would be positively influenced by the student S.

FIG. 15D depicts an approach for the analysis for transition from Demonstrating to Maturity in Leadership abilities.

The objective is to perform analysis for transitioning the student S from Demonstrating of leadership abilities to Matured leadership (1572).

Obtain SPI1—a set of students who are positively influenced by the student S (1574).

Let Sn1 be the number of students in SPI1.

Determine the set SQ13={X|Y is in SPI1 and X is a classmate of Y} based on UMG database (1576).

Determine the set SQ14={X|Y is in SPI1 and X is positively influenced by Y} based on UMG database (1578).

Determine SQ15 as the union of SQ13 and SQ14 (1580).

Let SQn13 be the number of students in SQ15 (1582).

Determine ISum of each of the students in SQ15 (1584).

Order the elements of SQ15 in the increasing order of the ISum to result in an ordered set OSQ15 (1586).

Compute TCount=Gamma3*SQn13 (1588). Note that Gamma3 is a pre-defined threshold.

Select TCount students from OSQ15 to result in TSQ13 (1590).

Suggest to S to attempt to positively influence students in TSQ13 to achieve transitioning from Demonstrating to Maturity in Leadership abilities (1592). In due course of time, as S focuses on developing the leadership skills, the students in TSQ13 would be positively influenced by the student S.

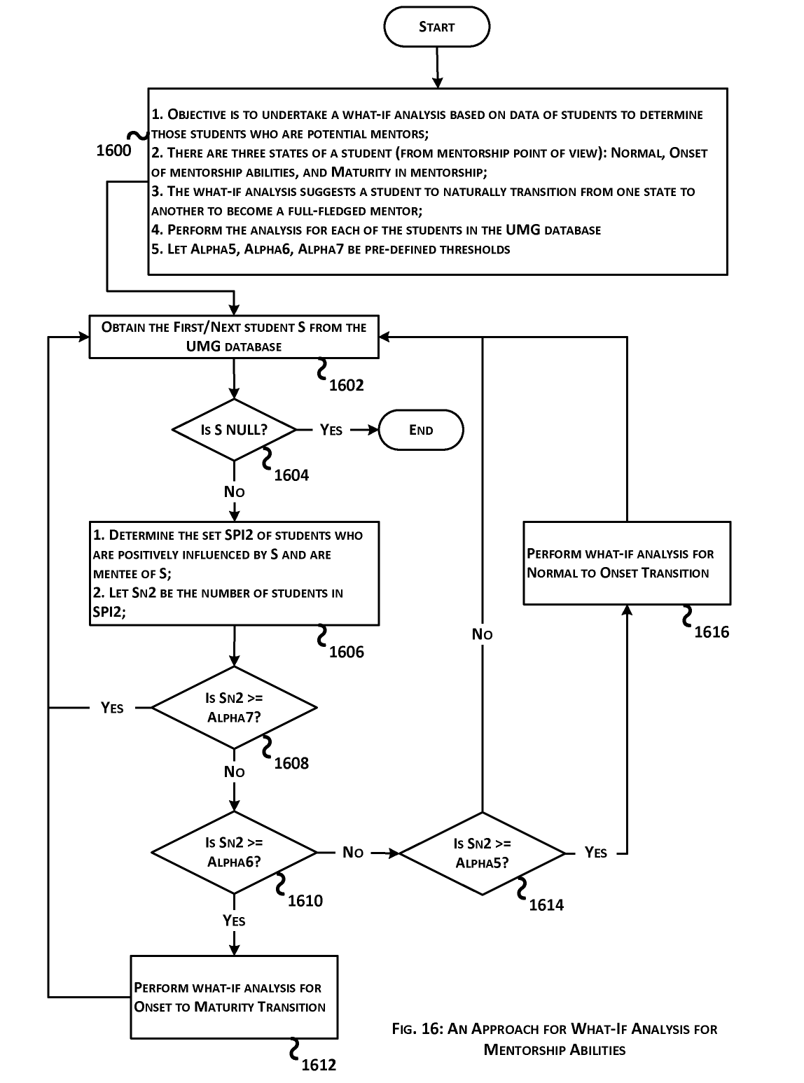

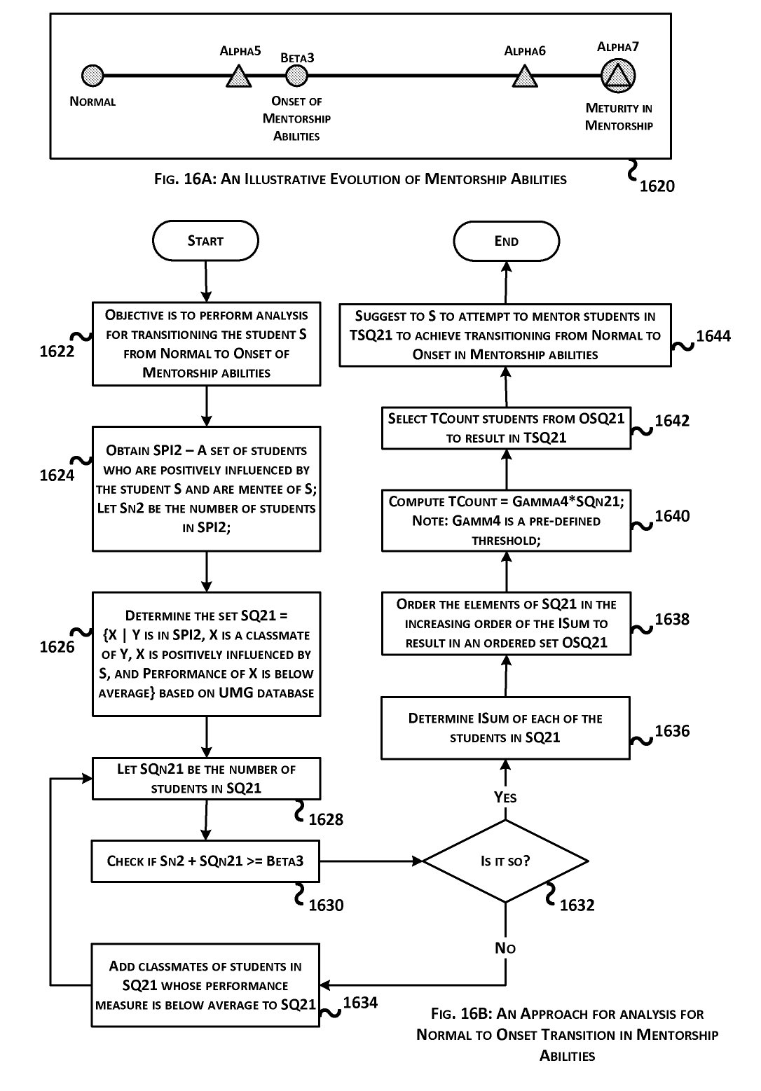

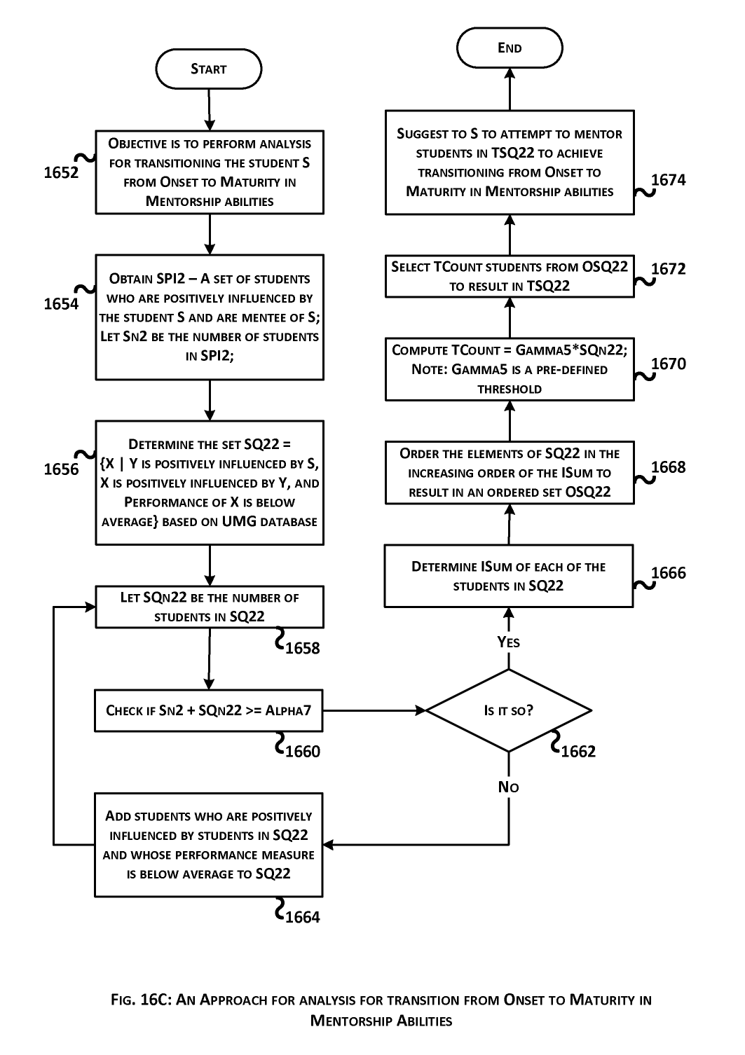

FIG. 16 provides an approach for What-If analysis for Mentorship abilities.

The objective is to undertake a what-if analysis based on data of students to determine those students who are potential mentors (1600).

There are three states of a student (from mentorship point of view): Normal, Onset of mentorship abilities, and Maturity in mentorship.

The what-if analysis suggests a student to naturally transition from one state to another to become a full-fledged mentor.

Perform the analysis for each of the students in the UMG database.

Let Alpha5, Alpha6, Alpha7 be pre-defined thresholds.

Obtain the First/Next student S from the UMG database (1602).

If there are no more students to processed (that is, S is NULL) (1604), then end.

Otherwise (1604), determine the set SPI2 of students who are positively influenced by S and are mentee of S (1606).

Let Sn2 be the number of students in SPI2.

If Sn2>=Alpha7 (1608), then the student is in the matured mentorship state and hence, no need to undertake any further what-if analysis. Proceed to Step 1602.

If it is not so (1608), check if Sn2>=Alpha6 (1610).

If it is so (1610), Perform what-if analysis for Onset to Maturity Transition (1612) and proceed to Step 1602 to process other remaining students.

If it is not so (1610), check if Sn2>=Alpha5 (1614).

If it is so (1614), Perform what-if analysis for Normal to Onset Transition (1616) and proceed to Step 1602 to process other remaining students.

If it is no so (1614), the student S is yet to show keenness in developing mentorship abilities.

Proceed to Step 1602 to process other remaining students.

FIG. 16A depicts an illustrative evolution of Mentorship abilities.

The state of a mentorship ability of the student S is determined based on the extent of positive influence on a set of students by S who are also mentees of S. The Step 1620 depicts how the extent of positive influence and being mentees is related to the various states of mentorship. For example, if the extent is greater than or equal to Beta3, then it is concluded that the student S has displayed the Onset of mentorship abilities. Observe that the student is nurtured towards this state when the extent becomes greater than or equal to Alpha5. Similarly, the step depicts the relationship between the threshold values Alpha6 and Alpha7, and the state of mentorship, namely, Maturity in mentorship.

FIG. 16B depicts an approach for the analysis for Normal to Onset transition in Mentorship abilities. The objective is to perform analysis for transitioning the student S from Normal to Onset of Mentorship abilities (1622).

Obtain SPI2—a set of students who are positively influenced by the student S and are mentee of S (1624).

Let Sn2 be the number of students in SPI2.

Determine the set SQ21={X|Y is in SPI2, X is a classmate of Y, X is positively influenced by S, and Performance of X is below average} based on UMG database (1626). Note that the performance measure of a student (say, X) is determined using a set of assessments (also called as base scores) that is part of the UMG database.

Let SQn21 be the number of students in SQ21 (1628).

Check if Sn2+SQn21>=Beta3 (1630).

If it is not so (1632), add classmates of students in SQ21 whose performance measure is below average to SQ21 (1634) and proceed to Step 1628.

If it is so (1632), determine ISum (influence sum) of each of the students in SQ21 (1636).

Order the elements of SQ21 in the increasing order of the ISum to result in an ordered set OSQ21 (1638).

Compute TCount (Target count of students)=Gamma4*SQn21 (1640). Note that Gamm4 is a pre-defined threshold.

Select TCount students from OSQ21 to result in TSQ21 (1642).

Suggest to S to attempt to mentor students in TSQ21 to achieve transitioning from Normal to Onset in Mentorship abilities (1644). In due course of time, as S focuses on developing the mentorship skills, the students in TSQ21 would become the mentee of student S.

FIG. 16C provides an approach for the analysis for transition from Onset to Maturity in Mentorship abilities.

The objective is to perform the analysis for transitioning the student S from Onset to Maturity in Mentorship abilities (1652).

Obtain SPI2—a set of students who are positively influenced by the student S and are mentee of S (1654).

Let Sn2 be the number of students in SPI2.

Determine the set SQ22={X|Y is positively influenced by S, X is positively influenced by Y, and Performance of X is below average} based on UMG database (1656).

Let SQn22 be the number of students in SQ22 (1658).

Check if Sn2+SQn22>=Alpha7 (1660).

If it is not so (1662), add students who are positively influenced by students in SQ22 and whose performance measure is below average to SQ22 (1664), and proceed to Step 1658.

If it is so (1662), Determine ISum (influence sum) of each of the students in SQ22 (1666).

Order the elements of SQ22 in the increasing order of the ISum to result in an ordered set OSQ22 (1668).

Compute TCount (target count of students)=Gamma5*SQn22 (1670). Note that Gamma5 is a pre-defined threshold.

Select TCount students from OSQ22 to result in TSQ22 (1672).

Suggest to S to attempt to mentor students in TSQ22 to achieve transitioning from Onset to Maturity in Mentorship abilities (1674). In due course of time, as S focuses on developing the mentorship skills, the students in TSQ22 would become the mentee of student S.

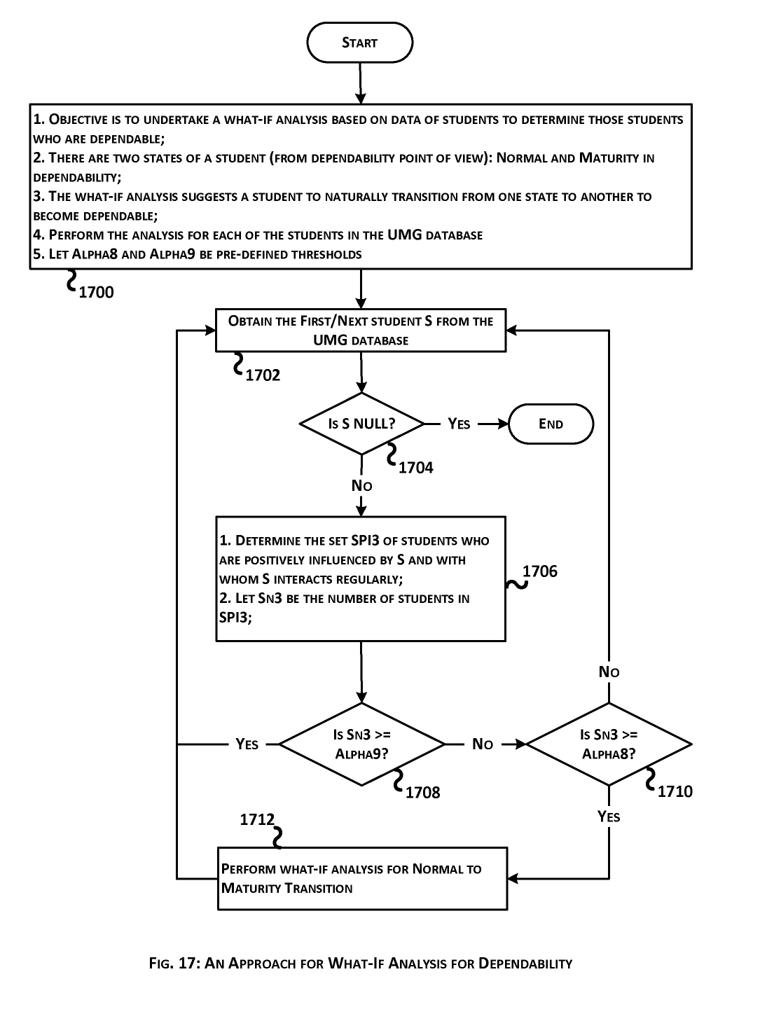

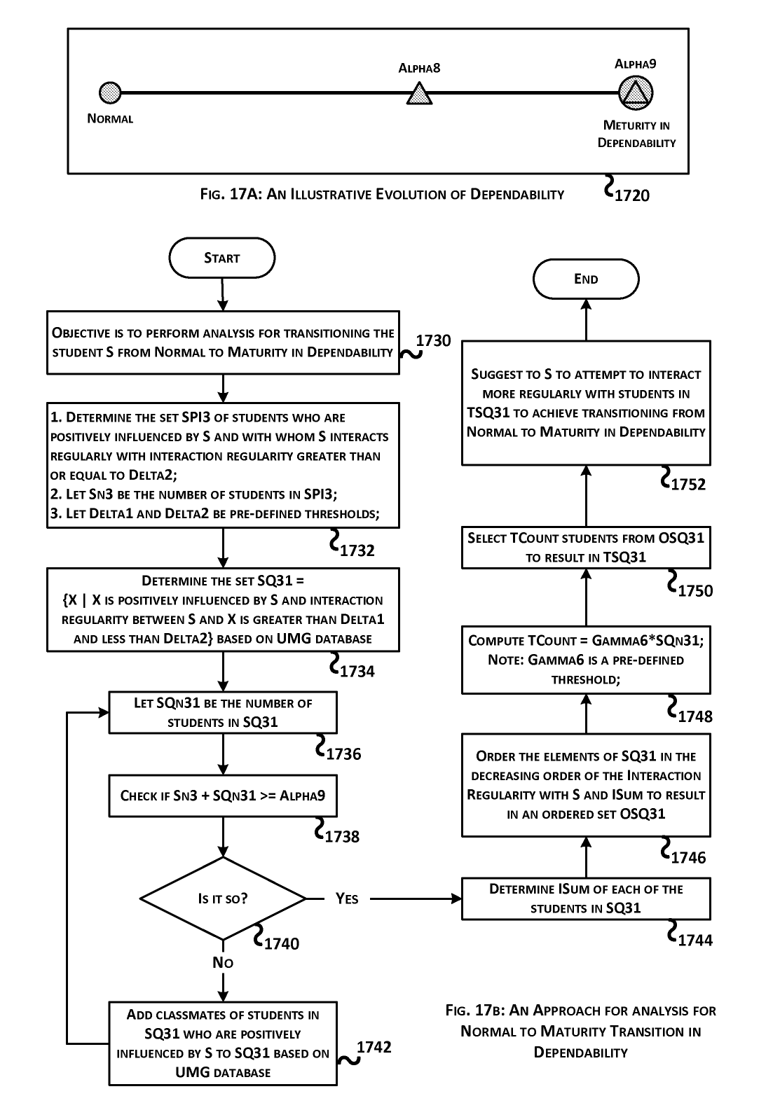

FIG. 17 provides an illustrative What-If analysis for Dependability.

The objective is to undertake a what-if analysis based on data of students to determine those students who are dependable (1700).

There are two states of a student (from dependability point of view): Normal and Maturity in dependability.

The what-if analysis suggests a student to naturally transition from one state to another to become dependable.

Perform the analysis for each of the students in the UMG database.

Let Alpha8 and Alpha9 be pre-defined thresholds.

Obtain the First/Next student S from the UMG database (1702).

If there are no more students to be processed (that is, S is NULL) (1704), then proceed to end.

Otherwise (1704), determine the set SPI3 of students who are positively influenced by S and with whom S interacts regularly (1706). In a particular embodiment, the interaction regularity is measured as a value between 0 and 1, and interacts regularly means that the interaction regularity is greater than or equal to Delta2. Note that Delta2 is a pre-defined threshold. In a particular embodiment, interaction regularity between two students gets measured by analyzing the multiple meeting times between the two students, arriving at a typical meeting time, and computing the deviation of the meeting times with respect to the typical meeting time.

Let Sn3 be the number of students in SPI3.

Check If Sn3>=Alpha9 (1708) and if it is so, the student S is already in the matured state of dependability, and hence, proceed to Step 1702 to process other remaining students.

Otherwise (1708), check if Sn3>=Alpha8 (1710).

If it is so (1710), perform what-if analysis for Normal to Maturity Transition (1710) and proceed to

Step 1702 to process the remaining of the students.

If it is not so (1710), the student S is yet to show keenness in developing dependability abilities.

Proceed to Step 1702 to process other remaining students.

FIG. 17A depicts an illustrative evolution of Dependability.

The state of a dependability of the student S is determined based on the extent of positive influence on a set of students by S and the interaction regularity with them. The Step 1720 depicts how this extent is related to the various states of dependability.

For example, if the extent is greater than or equal to Alpha9, then it is concluded that the student S has displayed the maturity in dependability. Observe that the student is nurtured towards this state when the extent becomes greater than or equal to Alpha8.

FIG. 17B provides an approach for the analysis for Normal to Maturity transition in Dependability.

The objective is to perform analysis for transitioning the student S from Normal to Maturity in Dependability (1730).

Determine the set SPI3 of students who are positively influenced by S and with whom S interacts regularly with interaction regularity greater than or equal to Delta2 (1732).

Let Sn3 be the number of students in SPI3.

Let Delta1 and Delta2 be pre-defined thresholds.

Determine the set SQ31={X|X is positively influenced by S and interaction regularity between S and X is greater than Delta1 and less than Delta2} based on UMG database (1734).

Let SQn31 be the number of students in SQ31 (1736).

Check if Sn3+SQn31>=Alpha9 (1738).

If it is not so (1740), add classmates of students in SQ31 who are positively influenced by S to SQ31 based on UMG database (1742) and proceed to Step 1736.

If it is so (1740), determine ISum (influence sum) of each of the students in SQ31 (1744).

Order the elements of SQ31 in the decreasing order of the Interaction Regularity with S and ISum to result in an ordered set OSQ31 (1746).

Compute TCount (target count of students)=Gamma6*SQn31 (1748). Note that Gamma6 is a pre-defined threshold.

Select TCount students from OSQ31 to result in TSQ31 (1750).

Suggest to S to attempt to interact more regularly with the students in TSQ31 to achieve transitioning from Normal to Maturity in Dependability (1752). In due course of time, as S focuses on developing the dependability skills, the student S would interact more regularly with the students in TSQ31.

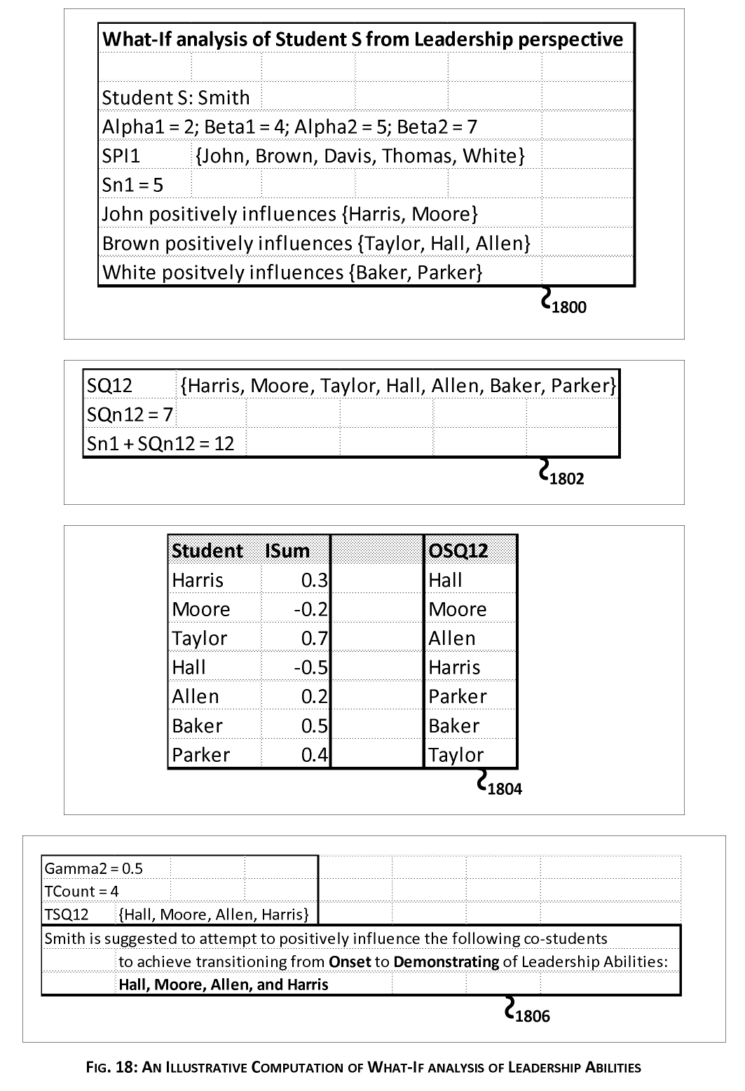

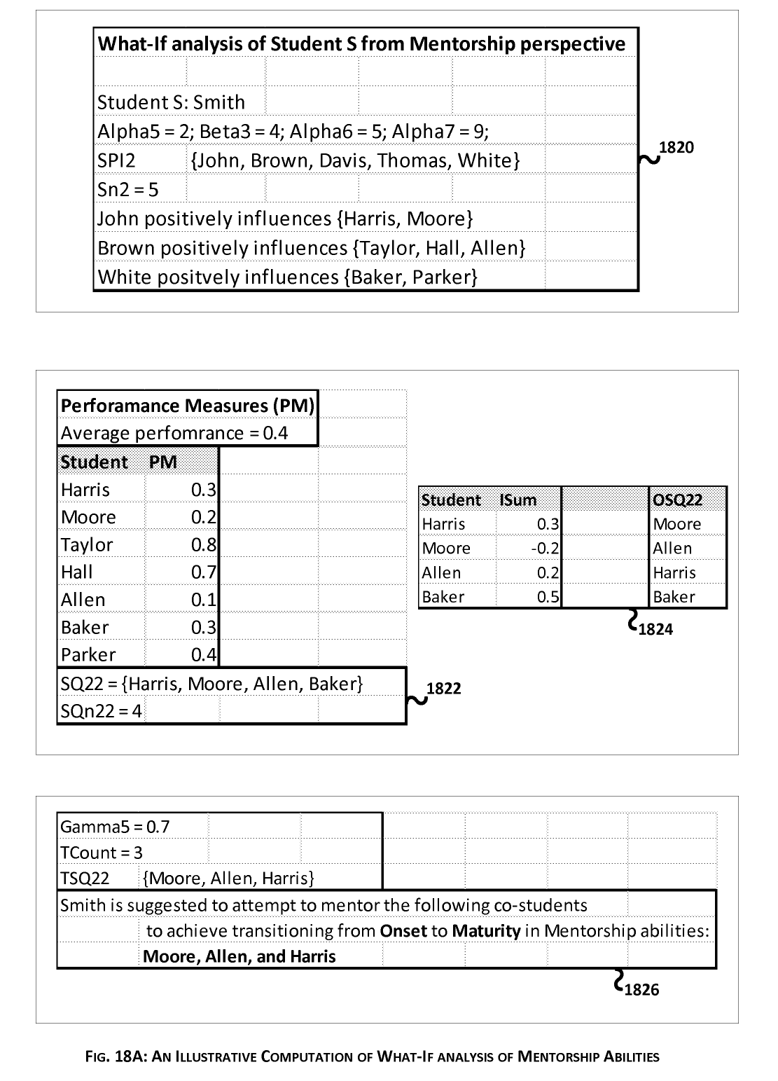

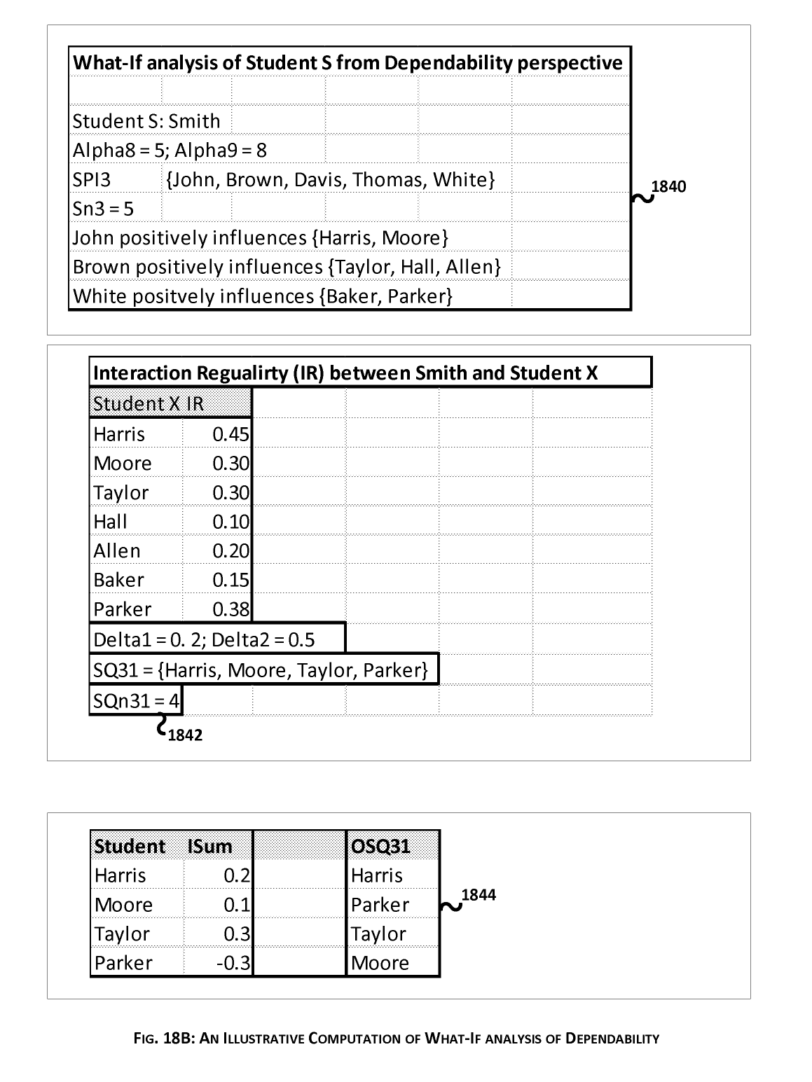

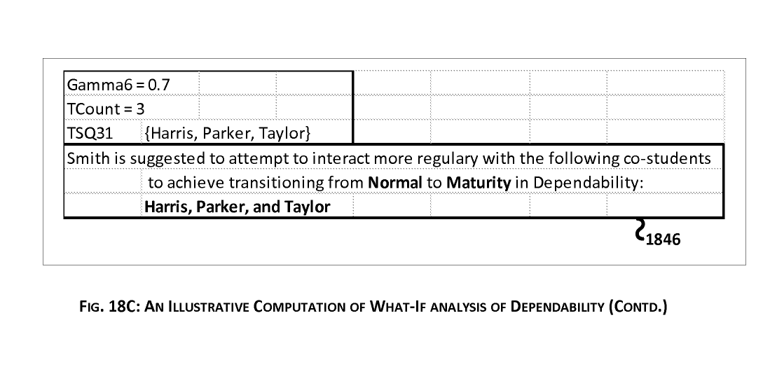

FIG. 18 depicts an illustrative computation of What-If analysis of Leadership abilities.

The Step 1800 provides the various threshold values and the set SPI1 with respect to the student Smith. Note that the count Sn1 is 5. Further, the positive influences of the students in SPI1 are also provided.

The Step 1802 depicts the set SQ12 and the associated count SQn12 (=7). Note that Sn1+SQn12 exceeds Beta2 (=7).

The Step 1804 provides the ISum values for the students in SQ12 and the ordered set OSQ12 ordered on ISum.

Finally, the step 1806 depicts the selected students TSQ12 (={Hall, Moore, Allen, Harris}) from OSQ12 and suggests the student Smith to attempt to positively influence the co-students in TSQ12 to achieve transitioning from Onset to Demonstrating of Leadership Abilities.

FIG. 18A depicts an illustrative computation of What-If analysis of Mentorship abilities.

The Step 1820 provides the various threshold values and the set SP12 with respect to the student Smith. Note that the count Sn2 is 5. Further, the positive influences of the students in SP12 are also provided.

The Step 1822 depicts the set SQ22 (={Harris, Moore, Allen, Baker}) and the associated count SQn22 (=4) based on the performance measures of the various students.

Note that Sn2+SQn22 is greater than or equal to Alpha7 (=9).

The Step 1824 provides the ISum values for the students in SQ22 and their ordered set OSQ22.

Finally, the step 1826 depicts the selected students TSQ22 (={Moore, Allen, Harris}) from OSQ22 and suggests the student Smith to attempt to mentor the co-students in TSQ22 to achieve transitioning from Onset to Maturity in Mentorship Abilities.

FIG. 18B provides an illustrative computation of What-If analysis of Dependability.

The Step 1840 provides the various threshold values and the set SPI3 with respect to the student Smith. Note that the count Sn3 is 5. Further, the positive influences of the students in SPI3 is also provided.

The Step 1842 depicts the set SQ31 (={Harris, Moore, Taylor, Parker}) and the associated count SQn31 (=4) based on the interaction regularity of the student Smith with the various students. Note that Sn3+SQn31 exceeds Alpha9 (=8).

The Step 1844 provides the ISum values for the students in SQ31 and their ordered set OSQ31. Note that the ordering is based on the decreasing order of the interaction regularities and ISum values.

FIG. 18C provides additional information related to the illustrative computation of What-If analysis of Dependability.

Finally, the step 1846 depicts the selected students TSQ31 (={Harris, Parker, Taylor}) from OSQ31 and suggests the student Smith to attempt to interact more regularly with the co-students in TSQ31 to achieve transitioning from Normal to Maturity in Dependability.

Thus, a system and method for what-if analysis based on a university model graph is disclosed. Although the present invention has been described particularly with reference to the figures, it will be apparent to one of the ordinary skill in the art that the present invention may appear in any number of systems that provide for what-if analysis of influence based structural representation. It is further contemplated that many changes and modifications may be made by one of ordinary skill in the art without departing from the spirit and scope of the present invention.

We claim:

1. A computer-implemented method for what-if analysis of data related to a plurality of students of an educational institution with respect to a plurality of leadership abilities, a plurality of mentorship abilities, and a plurality of dependability abilities of said plurality of students using a structural representation of said educational institution in the form of a university model graph comprising a plurality of assessments and a plurality of influence values based on a university model graph (UMG) database and said plurality of students of said educational institution,
wherein said plurality of leadership abilities comprises of a plurality of onset of leadership abilities, a plurality of demonstrating of leadership abilities, and a plurality of matured leadership abilities, said plurality of mentorship abilities comprises of a plurality of onset of mentorship abilities and a plurality of matured mentorship abilities,
said plurality of dependability abilities comprising a plurality of matured dependability abilities, said method performed on a computer system comprising at least one processor, one or more memory units, and one or more network interfaces for connecting said computer system to an Internet Protocol (IP) network, said method comprising the steps of:
determining, with at least one processor, a student (S) of said plurality of students;
determining, with at least one processor, a plurality of first positively influenced students (SPI1) of said plurality of students, wherein each student of said SPI1 is positively influenced by said S;
determining, with at least one processor, a first pre-defined threshold (alpha1), a second pre-defined threshold (alpha2), a third pre-defined threshold (alpha3), a fourth pre-defined threshold (alpha4), a fifth pre-defined threshold (beta1), and a sixth pre-defined threshold (beta2);
determining, with at least one processor, a first student count (Sn1) based on said SPI1;
performing what-if analysis, with at least one processor, to make said S a part of said plurality of matured leadership abilities of said plurality of leadership abilities, wherein said Sn1 is greater than or equal to said alpha4;
performing what-if analysis for demonstrating to maturity transition of said plurality of leadership abilities, with at least one processor, to determine a plurality of first 3 influenced students based on said S, said plurality of influence values, and said UMG database wherein said Sn1 is greater than or equal to said alpha3;
making, with at least one processor, said S a part of said plurality of matured leadership abilities of said plurality of leadership abilities based on said Sn1, said plurality of first 3 influenced students, and said alpha4;
performing what-if analysis for onset to demonstrating transition of said plurality of leadership abilities, with at least one processor, to determine a plurality of first 2 influenced students based on said S and said plurality of influence values, wherein said Sn1 is greater than or equal to said alpha2;
making, with at least one processor, said S a part of said plurality of demonstrating of leadership abilities of said plurality of leadership abilities based on said Sn1, said plurality of first 2 influenced students, and said beta2;
performing what-if analysis for normal to onset transition of said plurality of leadership abilities, with at least one processor, to determine a plurality of first 1 influenced students based on said S, said plurality of influence values, and said UMG database, wherein said Sn1 is greater than or equal to said alpha1;
making, with at least one processor, said S a part of said plurality of onset of leadership abilities of said plurality of leadership abilities based on said Sn1, said plurality of first 1 influenced students, and said beta1;
determining, with at least one processor, a plurality of second positively influenced students (SPI2) of said plurality of students, wherein each student of said SPI2 is positively influenced by said S and each student of said SPI2 is a mentee of said S;
determining, with at least one processor, a seventh pre-defined threshold (alpha5), an eighth pre-defined threshold (alpha6), a ninth pre-defined threshold (alpha7), and a tenth pre-defined threshold (beta3);
determining, with at least one processor, a second student count (Sn2) based on said SPI2;
performing what-if analysis, with at least one processor, to make said S a part of said plurality of matured mentorship abilities of said plurality of mentorship abilities, wherein said Sn2 is greater than or equal to said alpha7;
performing what-if analysis for onset to maturity transition of said plurality of mentorship abilities, with at least one processor, to determine a plurality of second 2 targeted mentees based on said S, said plurality of influence values, said plurality of assessments, and said UMG database, wherein said Sn2 is greater than or equal to said alpha6;
making, with at least one processor, said S a part of said plurality of matured mentorship abilities of said plurality of mentorship abilities based on said Sn2, said plurality of second 2 targeted mentees, and said alpha7;
performing what-if analysis for normal to onset transition of said plurality of mentorship abilities, with at least one processor, to determine a plurality of second 1 targeted mentees based on said S, said plurality of influence values, said plurality of assessments, and said UMG database, wherein said Sn2 is greater than or equal to said alpha5;
making, with at least one processor, said S a part of said plurality of onset of mentorship abilities of said plurality of mentorship abilities based on said Sn2, said plurality of second 1 targeted mentees, and said beta3;
determining, with at least one processor, an eleventh pre-defined threshold (delta1) and a twelfth pre-defined threshold (delta2);
determining, with at least one processor, a plurality of third positively influenced students (SPI3) of said plurality of students, wherein each student of said SPI3 is positively influenced by said S and an interaction regularity between said S and each student of said SPI3 greater than or equal to said delta 2;
determining, with at least one processor, a thirteenth pre-defined threshold (alpha8) and a fourteenth pre-defined threshold (alpha9);
determining, with at least one processor, a third student count (Sn3) based on said SPI3;
performing what-if analysis, with at least one processor, to make said S a part of said plurality of matured dependability abilities of said plurality of dependability abilities, wherein said Sn3 is greater than or equal to said alpha9; and
performing what-if analysis for normal to maturity transition of said plurality of dependability abilities, with at least one processor, to determine a plurality of third 1 regularly interacting students based on said S, said plurality of influence values, and said UMG database wherein said Sn3 is greater than or equal to said alpha8; and
making, with at least one processor, said S a part of said plurality of matured dependability abilities of said plurality of dependability abilities based on said Sn3, said plurality of third 1 regularly interacting students, and said alpha9.

2. The method of claim 1, wherein said step for performing what-if analysis for normal to onset transition of said plurality of leadership abilities further comprising the steps of:
computing a plurality of first 1 students (SQ11) based on said S, said plurality of students, and said UMG database, wherein a student X of said SQ11 is a classmate of a student Y of said SPI1;
adding a student 1 of said plurality of students to said SQ11 based on said UMG database, wherein said student 1 is a classmate of a student 2 of said SQ11;
determining a first 1 student count (SQn11) based on said SQ11;
computing a sum of said Sn1 and said SQn11, wherein said sum exceeds said beta1;
computing a plurality of influence sums (ISum) based on said SQ11 and said plurality of influence values, wherein an influence sum of said ISum is the sum of the influences of a student 3 of said SQ11;
ordering said SQ11 to result in a plurality of ordered first 1 students (OSQ11) in the increasing order of said ISum;
computing a target student count (TCount) as a product of said SQn11 and a fifteenth pre-defined threshold (gamma1);
selecting said TCount of students from said OSQ11 to result in said a plurality of first 1 targeted students (TSQ11); and
determining said plurality of first 1 influenced students based on said TSQ11, wherein each of said plurality of first 1 influenced students is positively influenced by said S.

3. The method of claim 1, wherein said step for performing what-if analysis for onset to demonstrating transition of said plurality of leadership abilities further comprising the steps of:
computing a plurality of first 2 students (SQ12) based on said S, said plurality of students, and said plurality of influence values, wherein a student X of said SQ12 is positively influenced by a student Y of said SPI1;
adding a student 1 of said plurality of students to said SQ12 based on said plurality of influence values, wherein said student 1 is positively influenced by a student 2 of said SQ12;
determining a first 2 student count (SQn12) based on said SQ12;
computing a sum of said Sn1 and said SQn12, wherein said sum exceeds said beta2;
computing a plurality of influence sums (ISum) based on said SQ12 and said plurality of influence values, wherein an influence sum of said ISum is the sum of the influences of a student 3 of said SQ12;
ordering said SQ12 to result in a plurality of ordered first 2 students (OSQ12) in the increasing order of said ISum;
computing a target student count (TCount) as a product of said SQn12 and a sixteenth pre-defined threshold (gamma2);
selecting said TCount of students from said OSQ12 to result in a plurality of first 2 targeted students (TSQ12); and
determining said plurality of first 2 influenced students based on said TSQ12, wherein each of said plurality of first 2 influenced students is positively influenced by said S.

4. The method of claim 1, wherein said step for performing what-if analysis for demonstrating to maturity transition of said plurality of leadership abilities further comprising the steps of:
computing a plurality of first 3 students (SQ13) based on said S, said plurality of students, and said UMG database, wherein a student X of said SQ13 is a classmate of a student Y of said SPI1;
computing a plurality of first 4 students (SQ14) based on said S, said plurality of students, and said plurality of influence values, wherein a student 1 of said SQ14 is positively influenced by a student 2 of said SPI1;
computing a plurality of first 5 students (SQ15) as a union of said SQ13 and said SQ14.
determining a first 3 student count (SQn13) based on said SQ15;
computing a plurality of influence sums (ISum) based on said SQ15 and said plurality of influence values, wherein an influence sum of said ISum is the sum of the influences of a student 3 of said SQ15;
ordering said SQ15 to result in a plurality of ordered first 5 students (OSQ15) in the increasing order of said ISum;
computing a target student count (TCount) as a product of said SQn13 and a seventeenth pre-defined threshold (gamma3);
selecting said TCount of students from said OSQ15 to result in a plurality of first 3 targeted students (TSQ13); and
determining said plurality of first 3 influenced students based on said TSQ13, wherein each of said plurality of first 3 influenced students is positively influenced by said S.

5. The method of claim 1, wherein said step for performing what-if analysis for normal to onset transition of said plurality of mentorship abilities further comprising the steps of:
computing a plurality of second 1 students (SQ21) based on said S, said plurality of students, said plurality of influence values, said plurality of assessments, and said UMG database, wherein a student X of said SQ21 is a classmate of a student Y of said SPI2, said student X is positively influenced by said S, and a performance measure of said student X is below average;
adding a student 1 of said plurality of students to said SQ21 based on said plurality of assessments and said UMG database, wherein said student 1 is a classmate of a student 2 of said SQ21 and a performance measure of said student 1 is below average;
determining a second 1 student count (SQn21) based on said SQ21;
computing a sum of said Sn2 and SQn21, wherein said sum exceeds said beta3;
computing a plurality of influence sums (ISum) based on said SQ21 and said plurality of influence values, wherein an influence sum of said ISum is the sum of the influences of a student 3 of said SQ21;
ordering said SQ21 to result in a plurality ordered second 1 of students (OSQ21) in the increasing order of said ISum;
computing a target student count (TCount) as a product of said SQn21 and an eighteenth pre-defined threshold (gamma4);
selecting said TCount of students from said OSQ21 to result in a plurality of second 1 targeted students (TSQ21); and
determining said plurality of second 1 targeted mentees based on said TSQ21, wherein each of said plurality of second 1 targeted mentees is a student 4 of said TSQ21 and is a mentee of said S.

6. The method of claim 1, wherein said step for performing what-if analysis for onset to maturity transition of said plurality of mentorship abilities further comprising the steps of:
computing a plurality of second 2 students (SQ22) based on said S, said plurality of students, said plurality of influence values, said plurality of assessments, and said UMG database, wherein a student X of said SQ22 is positively influenced by a student Y of said SPI2 and a performance measure of said student X is below average;
adding a student 1 of said plurality of students to said SQ22 based on said plurality of influence values, said plurality of assessment, and said UMG database, wherein said student 1 is positively influenced by a student 2 of said SQ22 and a performance measure of said said student 1 is below average;
determining a second 2 student count (SQn22) based on said SQ22;
computing a sum of said Sn2 and SQn22, wherein said sum exceeds said alpha7;
computing a plurality of influence sums (ISum) based on said SQ22 and said plurality of influence values, wherein an influence sum of said ISum is the sum of the influences of a student 3 of said SQ22;
ordering said SQ22 to result in a plurality of ordered second 2 students (OSQ22) in the increasing order of said ISum;
computing a target student count (TCount) as a product of said SQn22 and a nineteenth pre-defined threshold (gammas);
selecting said TCount of students from said OSQ22 to result in a plurality of second 2 targeted students (TSQ22); and
determining said plurality of second 2 targeted mentees based on said TSQ22 wherein each of said plurality of second 2 targeted mentees is a student 4 of said TSQ22 and is a mentee of said S.

7. The method of claim 1, wherein said step for performing what-if analysis for normal to maturity transition of said plurality of dependability abilities further comprising the steps of:
computing a plurality of third 1 students (SQ31) based on said S, said plurality of students, said plurality of influence values, and said UMG database, wherein a student X of said SQ31 is positively influenced by said S, an interaction regularity (IR) associated with said S and said student X is a measure of interaction regularity between said S and said student X, said IR is greater than said delta1, and said IR is less than said delta2;
adding a student 1 of said plurality of students to said SQ31 based on said plurality of influence values and said UMG database, wherein said student 1 is a classmate of a student 2 of said SQ31 and said student 1 is positively influenced by said S;
determining a third 1 student count (SQn31) based on said SQ31;
computing a sum of said Sn3 and SQn31, wherein said sum exceeds said alpha9;
computing a plurality of influence sums (ISum) based on said SQ31 and said plurality of influence values, wherein an influence sum of said ISum is the sum of the influences of a student 3 of said SQ31;
computing a plurality of interaction regularities based on said SQ31 and said UMG database, wherein an interaction regularity 1 of said plurality of interaction regularities is a measure of an interaction regularity between said S and a student 4 of said SQ31;
ordering said SQ31 to result in a plurality of ordered third 1 students (OSQ31) in the decreasing order of said plurality of interaction regularities and said ISum;
computing a target student count (TCount) as a product of said SQn31 and a twentieth pre-defined threshold (gamma6);
selecting said TCount of students from said OSQ31 to result in a plurality of third 1 targeted students (TSQ31); and
determining said plurality of third 1 regularly interacting students based on said TSQ31, wherein each of said plurality of third 1 regularly interacting students is a student 5 of said TSQ31 and interacts regularly with said S.
